(19) United States
(12) Patent Application Publication
(10) Pub. No.: US 2007/0010328 A1
(43) Pub. Date: Jan. 11, 2007

(54) Game system

(76) Inventors: Kaoru Yokota, Hyogo (JP); Motoji Ohmori, Osaka (JP); Yuichi Futa, Osaka (JP); Toshihisa Nakano, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/574,078

(22) PCT Filed: Oct. 25, 2004
(86) PCT No.: PCT/JP04/16189

§ 371 Date: Mar. 30, 2006

(30) Foreign Application Priority Data
Oct. 29, 2003 (JP) 2003-369550

(51) Int. Cl. A63F 13/00

(52) U.S. Cl. 463/42

(57) ABSTRACT

A game system is composed of a home game execution apparatus and a portable game execution apparatus. The home game execution apparatus generates image data suitable for the image quality of the home game execution apparatus and image data suitable for the image quality of the portable game apparatus, transmits the pieces of the image data as necessary, and writes a game program to a portable recording medium. The portable game execution apparatus executes the game recorded on the portable recording medium while displaying the portable image received over the network. As a result, each game execution apparatus is able to execute the same game while displaying image data of an image quality suitable for the particular game execution apparatus.

### TECHNICAL FIELD

The present invention relates to a computer game processing technique for executing a game by operating in accordance with a computer program that describes an execution procedure of the game.

### BACKGROUND ART

Following advances in computer technology in recent years, both home game machines with high processing ability, and compact, portable game machines have been developed, and are currently on the market.

Such game machines execute a game by operating following a computer program that describes an execution procedure and the like of the game. In such games, a virtual objects called a character appears, and the user is able to enjoy the game by controlling the movements of the character as he or she wishes. Various virtual abilities of the character increase and decrease as the game progresses, and the shape of the character also changes in accordance with the changes in the virtual abilities.

If the user stops the game part way through, the game machine stores information indicating the point at which the game was stopped, and properties such as the abilities and shape of the character at that point. When the user resumes the game, the game machine reads the information indicating the point at which the game was stopped, and the characteristics such as the abilities and shape, and restores the character having the abilities and shape as the time that the game was stopped. The game then proceeds from this point.

However, in most cases, computer programs for home game machines and computer programs for portable game machines are provided on different media. For example, a computer program for a home game machine is usually provided to the user stored on an optical disc, whereas a computer program for a portable game machine is usually provided to the user stored in a special-purpose cartridge. For this reason, an optical disc that stores a computer program for a home game machine cannot be mounted in a portable game machine, and a special-purpose cartridge that stores a computer program for a portable game machine cannot be mounted in a home game machine.

Furthermore, home game machines and portable game machines differ in aspects such as system architecture, type and number of processors, and screen display ability. Therefore, a computer program for a home game machine is not designed to be executable in a portable game machine, and a computer program for a portable game machine is not designed to be executable in a home game machine.

Reference 1 and Reference 2 disclose emulator programs that attempt to solve the problem of game software for an old (subordinate) game machine sold in the past being unusable in a new (superordinate) game machine having higher processing ability than the old game machine. These emulator programs enable the game program for the subordinate machine to be executed in the superordinate machine by emulating the subordinate machine.

Reference 3 discloses an emulator distribution system that makes a subordinate game program executable in a superordinate machine by receiving an emulator program from a distribution apparatus.

Furthermore, Reference 4 is a product that enables game software for a portable game machine to be used in a home machine using a special-purpose adapter.

However, the technique disclosed by Reference 4 presents a problem in that, while portable game machine software can be executed in a home game machine, since the image date included the portable game machine software is only of the image quality adequate for a portable game machine, images can only be displayed by the home game machine with the low image quality of the portable game machine, despite the home game machine having the ability to display high-quality images.

Patent Document 1: JP 2001-340640, A

Patent Document 2: JP 2001-340641, A

Patent Document 3: JP 2001-340655, A

Patent Document 4: JP 3313-21, B

Patent Document 5: JP 2001-331812, A

Non-Patent Document 1:

http://www.nintendo.co.jp/ngc/acce/gbplayer (current as of Sep. 22, 2004)

Non-Patent Document 2:

David F. Rogers “Jissen Konpyuta Gurafikkusu (Procedural Elements of Computer Graphics)”, The Nikkan Kogyo Shimbun Ltd., Nov. 15, 1996

Non-Patent Document 3:

YAMASAKI Yukinori “Gemu Purogurama ni Naru Hon, IBM PC/AT Gokanki (Book for Becoming a Game Programmer, IBM PC/AT Compatible Machines)”, CQ Publishing Co., Ltd., Feb. 1, 1998

### DISCLOSURE OF THE INVENTION

In order to solve the stated problem, an object of the present invention is to provide a game system, a game execution apparatuses, a game execution method and a game execution program that are able have a same game proceed in each of two game execution apparatuses that display mutually differing image qualities, while displaying images in image qualities suitable for the respective game execution apparatuses.

In order to achieve the stated object, the present invention is a game system composed of a stationary game machine, a portable game machine, a memory card, a DVD (digital versatile disc), and server apparatus.

Recorded on the DVD are a stationary basic program executable by the stationary game machine, a portable basic program executable by the portable game machine, and general image data which, after conversion processing, is displayable by either the stationary game machine or the portable game machine.

Here, the game executed by the stationary basic program and the game executed by the portable basic program are the same game.

The user mounts the DVD in the stationary game machine, and also mounts the memory card in the stationary game machine.

The stationary game machine generates images suitable for the stationary game machine, from the general image data, when the game is executed according to user operation. When the game is stopped, the stationary game machine writes the portable basic program and save data that indicates the state of progress of the game at the point at the point at which the game was stopped, to the memory card.

The portable game machine and the stationary game machine are connected over the Internet. The user enjoys the game in accordance with the portable basic program, while the memory card is in a mounted state. At this time, the stationary game machine transmits portable image data that has been generated from the general image data to be suitable for the portable game machine, to the portable game machine over the Internet as necessary.

In this way, the user is able to enjoy the same game on both the stationary game machine and the portable game machine, with images suitable for the respective game machines.

The present invention is a game system including a stationary game execution apparatus, a mobile game execution apparatus and a monitor, each of the game execution apparatuses executing a game in accordance with a game program, the stationary game execution apparatus including: an obtaining unit operable to obtain the game program and general image data, the game program indicating a game procedure, and the general image data being for display in accordance with progression of the game; a write unit operable to write the obtained game program to a portable recording medium; a generation unit operable to generate stationary image data and portable image data from the obtained general data, the stationary image data being suitable for display by the stationary game execution apparatus, and the portable image data being suitable for display by the portable game apparatus; a transmission unit operable to transmit the generated portable image data over a network; an input unit operable to receive an input operation from a user; and an execution unit operable to execute, based on the received input operation, the game, in accordance with the procedure indicated by the obtained game program, and generate, in accordance with progression of the game, a stationary display image from the generated stationary image data, and output the generated stationary display image, the monitor displaying the output stationary display image, and the portable game apparatus including: a read unit operable to read the game program from the portable recording medium; a reception unit operable to receive the portable image data over the network; an input unit operable to receive an input operation from the user; an execution unit operable to execute, based on the received input operation, the game, in accordance with the procedure indicated by the read game program, and generate, in accordance with progression of the game, a portable display image from the received portable image data; and a display unit operable to display the generated portable display image.

Note that the present specification describes a home game machine as an example of a stationary game machine of the present invention.

With this structure, the stationary game execution apparatus reads the game program and the general data image from the game recording medium, writes the read game program to the portable recording medium, and, from the read general image data, generates stationary image data that is suitable for display by the stationary game execution apparatus, and portable image data that is suitable for display by the portable game execution apparatus. The stationary game execution apparatus then transmits the portable image data to the portable game execution apparatus over the network.

The portable game execution apparatus receives the portable image data over the network, reads the game program from the portable recording medium, and executes the game while generating portable display screens from the portable image data. Therefore, the game can be executed while displaying images of a quality suitable for the particular game execution apparatus.

Furthermore, since the images data is transmitted over the network, it is sufficient for the portable recording medium to have a relatively low capacity.

Here, the game system may further include a distribution server, the distribution server, including: a storage unit operable to store the game program; a read unit operable to read the game program from the storage unit; and a transmission unit operable to transmit the read game program securely over the network, and the mobile game execution apparatus further including: a reception unit operable to receive the game program over the network; and a write unit operable to write the received game program to the portable recording medium, wherein, instead of the stationary game execution apparatus writing the game program to the portable recording medium, the mobile game execution apparatus writes the received game program to the portable recording medium.

Generally, a game program executed by a stationary game execution apparatus and a game program executed by a portable game execution apparatus to differ. With the stated structure, the stationary game execution apparatus obtains only a game program executable by the stationary game execution apparatus, and the portable game execution apparatus obtains a game program executable by the portable game apparatus from the distribution server apparatus. The user is able to select whether or not to obtain the game program for the portable game apparatus, and therefore game software for the potable game execution apparatus can be obtained as necessary using the portable game execution apparatus. The seller of the game program is able to provide various forms of services according to requests from users.

Furthermore, with the stated structure, the portable game execution apparatus can obtain the game program from the distribution server over the network. The game program recorded in the distribution server apparatus is improved and maintained by the creator of the game apparatus program, and therefore the user is able to obtain the latest version of the game program.

Furthermore, the present invention is a stationary game execution apparatus that executes a game in accordance with a game program, including: an obtaining unit operable to obtain the game program and general image data, the game program indicating a game procedure, and the general image data being for display in accordance with progression of the game; a write unit operable to write the obtained game program to a portable recording medium; a generation unit operable to generate stationary image data and portable image data from the obtained general data, the stationary image data being suitable for display by the stationary game execution apparatus, and the portable image data being suitable for display by the portable game apparatus; a transmission unit operable to transmit the generated portable image data over a network; an input unit operable to receive an input operation from a user; and an execution unit operable to execute, based on the received input operation, the game, in accordance with the procedure indicated by the obtained game program, and generate, in accordance with progression of the game, a stationary display image from the generated stationary image data, and output the generated stationary display image to a monitor.

With the stated structure, the stationary game execution apparatus obtains the game program and the generation image data, writes the obtained game program to the portable recording medium, and, from the obtained general image data, generates stationary image data that is suitable for display by the stationary game execution apparatus, and portable image data that is suitable for display by the portable game execution apparatus. The stationary game execution apparatus then transmits the portable image data to the portable game execution apparatus over the network.

Therefore, the potable game execution apparatus receives the portable image data over the network, reads the game program from the portable recording medium, and executes the read game program while generating portable display images from the received portable image data. This enables the same game to be executed with images of a quality suitable for the respective game execution apparatus displayed.

Here, the game program and the general image data may be stored on a recording medium, and the obtaining unit may obtain the game program and the general image data by reading the game program and the general image data from the recording medium.

With this structure, since the game program and the general image data are recorded on the game recording medium, the obtaining unit is able to obtain the game program and the general image data reliably from the recording medium.

Here, a distribution server apparatus may store therein the game program and the general image data, and read the game program and transmits the read game program over the network, and the obtaining unit may obtain the game program and the general image data by receiving the game program and the image data from the distribution server apparatus over the network.

With this structure, the stationary game execution apparatus obtains the game program from the distribution server apparatus over the network. The game program recorded in the distribution server apparatus is improved and maintained by the creator of the game apparatus program, and therefore the user is able to obtain the latest version of the game program.

Here, in the stationary game execution apparatus of the present invention, by the generation unit transmitting the portable image data securely over the network, fraudulent use of data by a third party is prevented.

Here, by the generation unit generating, from the general image data, a portable image suitable for display by the portable game execution apparatus, and encrypting the generated portable image, thereby generating portable image data, fraudulent use of data by a third party is prevented because the data can only be used if decrypted correctly.

Here, by the generation unit generating a distribution key, and using the generated distribution key in encryption of the portable image, and the write unit further writing the generated distribution key to the portable recording medium, theft of data by a third party is prevented because the encryption cannot be decrypted without the distribution key.

Here, the input unit may further receive a stop instruction indicating stopping of the game at a point part way through, the execution unit may generate state data indicating a state of progression of the game at the point at which the stop operation was received, and the write unit may further write the generated state information to the portable recording medium. By recording the state of progress of the game at the point at which it was stopped on the portable recording medium, and by reading the stored state of progress, the game can be resumed on either the stationary game execution apparatus or the portable game execution apparatus from the point at which it was stopped.

Here, the stationary game execution apparatus may further include: a storage unit operable to store address information indicating a connection location of the stationary game execution apparatus on the network, wherein the write unit further reads the address information, and writes the address information to the portable recording medium.

With this function, when communication is performed between the stationary game execution apparatus and the portable game execution apparatus, the potable game apparatus can designate the communication destination accurately by reading the address information from the portable recording medium.

Furthermore, the present invention is a portable game execution apparatus that executes a game in accordance with a game program, wherein a stationary game execution apparatus obtains the game program and general image data, the game program indicating a game procedure, and the general image data being for display in accordance with progression of the game, writes the obtained game program to a portable recording medium, generates stationary image data and portable image data from the obtained general data, the stationary image data being suitable for display by the stationary game execution apparatus, and the portable image data being suitable for display by the portable game apparatus, and transmits the generated portable image data over a network, the portable game execution apparatus including: a read unit operable to read the game program from the portable recording medium; a reception unit operable to receive the portable image data over the network; an input unit operable to receive an input operation from the user; an execution unit operable to execute, based on the received input operation, the game, in accordance with the procedure indicated by the read game program, and generate, in accordance with progression of the game, a portable display image from the received portable image data; and a display unit operable to display the generated portable display image.

With this structure, the portable game execution apparatus receives the portable image data over the network, and executed the read game program while generating portable display images from the received portable image data. Therefore, the same game that is executed by the stationary game execution apparatus can be executed by the portable game execution apparatus while images are displayed with a quality suitable for the portable game execution apparatus.

Here, the reception unit may securely receive the portable image data over the network. Therefore, fraudulent use of data by a third party is prevented.

Here, the stationary game execution apparatus may generate, from the general image data, a portable image suitable for display by the portable game execution apparatus, and encrypt the generated portable image, thereby generating portable image data, and the execution unit may decrypt the received portable image data, thereby generating a portable image, and generate a portable display image from the generated portable image. With this function, fraudulent use of data by a third party is prevented because the data can only be used if decrypted correctly.

Here, the portable recording medium may further store a distribution key used in the encryption of the portable image, and the execution unit further reads the distribution key from the portable recording medium, and decrypt the received portable image data with use of the read distribution key. With this function, theft of data by a third party is prevented because the encryption cannot be decrypted without the distribution key.

Furthermore, the stationary game execution apparatus may generate a distribution key, generate, from the general image data, a portable image suitable for display by the portable game execution apparatus, encrypt the generated portable image with use of the generated distribution key, thereby generating portable image data, and transmit the portable image data over the network, the distribution server apparatus may generate a distribution key that is identical to the distribution key generated by the stationary game execution apparatus, and transmit the generated distribution key over the network, the reception unit may further receive the distribution key from the distribution server apparatus over the network, and write the received distribution key to the portable recording medium, and the execution unit may further read the distribution key from the portable recording medium, and decrypt the received portable image data with use of the read distribution key.

With these functions, fraudulent use of the encrypted portable image data by a third party is prevented because the encrypted portable image data cannot be decrypted without the decryption key.

Here, the portable recording medium may further store state data indicating a state of progression of the game at a point at which the game was stopped part way through, and the execution unit may further read the state data from the portable recording medium, and resume the game from the point at which the game was stopped, with use of the read state data. Accordingly, the game can be resumed from the state of progress at the point at which the game was stopped.

Here, the portable recording medium may further store address information indicating a connection location of the stationary game execution apparatus on the network, and the reception unit may read the address information from the portable recording medium, and receive the portable image data from the stationary game execution apparatus shown by the connection location on the network indicated by the read address information. Accordingly, the portable game execution apparatus can read the address information form the portable recording medium. Therefore, when communication is performed between the stationary game execution apparatus and the portable game execution apparatus, the potable game apparatus can designate the communication destination accurately by reading the address information from the portable recording medium.

Furthermore, in the portable game execution apparatus of the present invention, the distribution server apparatus may store the game program therein, and read the game program and transmits the read game program over the network, instead of the stationary game execution apparatus writing the game program to the portable recording medium, the reception unit may further receive the game program over the network, and write the received game program to the recording medium, and the read unit may read the game program that has been written to the portable recording medium by the reception unit, from the portable recording medium.

With these functions, the portable game execution apparatus is able to obtain the game program from the distribution server over the network, and write the game program to the portable recording medium. The game program recorded in the distribution server apparatus is improved and maintained by the creator of the game apparatus program, and therefore the user is able to obtain the latest version of the game program.

### BRIEF DESCRIPTION OF THE DRAWINGS

FIG. 1 shows the structure of a game system 10;

FIG. 2 shows the structure of a program and data recorded on a DVD 500a and a DVD 500b;

FIG. 3 shows an example of a screen displayed on a monitor 120 at a game step in a game stage;

FIG. 4 shows another example of a screen displayed on a monitor 120 at a game step in a game stage;

FIG. 5 shows yet another example of a screen displayed on a monitor 120 at a game step in a game stage;

FIG. 6 is a flowchart showing contents of processing by a home basic program, which continues in FIG. 7;

FIG. 7 is a flowchart showing contents of processing by the home basic program, which continues from FIG. 6;

FIG. 8 is a flowchart showing contents of a home frame processing program included in the home basic program, which continues in FIG. 9 and FIG. 10;

FIG. 9 is a flowchart showing contents of the home frame processing program included in the home basic program, which continues from FIG. 8;

FIG. 10 is a flowchart showing contents of the home frame processing program included in the home basic program, which continues from FIG. 8;

FIG. 11 is a flowchart showing contents of a home image generation program included in the home basic program;

FIG. 12 is a flowchart showing contents of processing according to a mobile basic program, which continues in FIG. 13;

FIG. 13 is a flowchart showing contents of processing according to a mobile basic program, which continues from FIG. 12;

FIG. 14 is a flowchart showing contents of a mobile frame processing program included in the mobile basic program, which continues in FIG. 15;

FIG. 15 is a flowchart showing contents of the mobile frame processing program included in the mobile basic program, which continues from FIG. 14;

FIG. 16 is a flowchart showing contents of a mobile image generation program included in the mobile basic program;

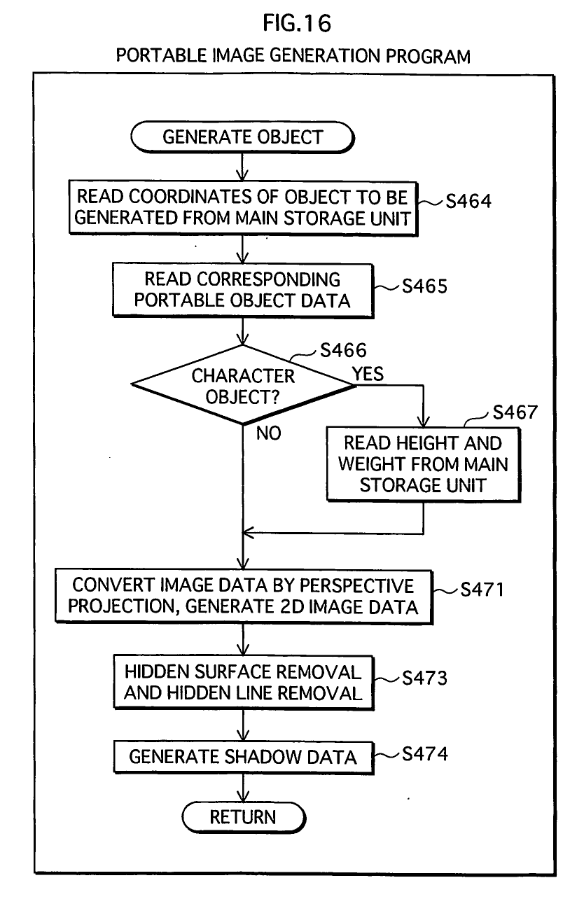

FIG. 17 is a block diagram showing the structure of a home game machine 100;

FIG. 18 shows an example of information stored in a main storage unit 110;

FIG. 19 shows an example of information stored in a large-capacity storage unit 111;

FIG. 20 shows an example of information stored in a graphic storage unit 114;

FIG. 21 shows an example of information stored in a register unit 109;

FIG. 22 shows types of instructions stored in a register R0 151 of the register unit 109;

FIG. 23 is a block diagram showing the structure of a memory card 306;

FIG. 24 is a block diagram showing the structure of a mobile game machine 200;

FIG. 25 shows an example of information stored in a main storage unit 210;

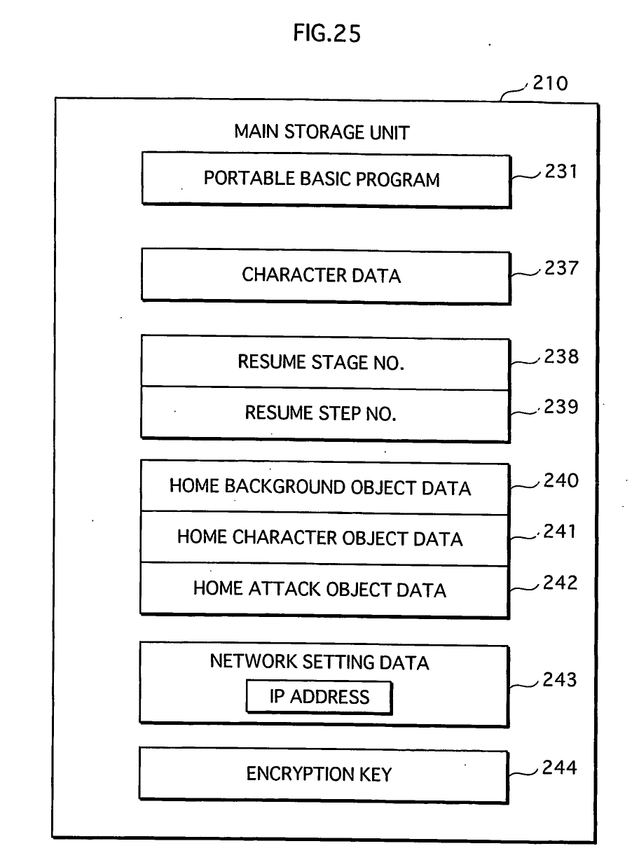

FIG. 26 is a block diagram showing the structure of a server apparatus 600;

FIG. 27 is a flowchart showing operations by the home game machine;

FIG. 28 is a flowchart showing home image data generation processing by the home game machine;

FIG. 29 is a flowchart showing game processing by the home game machine;

FIG. 30 is a flowchart showing mobile game image data transmission processing by the home game machine;

FIG. 31 shows operations for obtaining the mobile basic program and an encryption key from the server apparatus 600; and

FIG. 32 is a flowchart showing operations of the mobile game machine.

### BEST MODE FOR CARRYING OUT THE INVENTION

The following describes details of an embodiment of the present invention with use of the drawings.

### 1. First Embodiment

The following describes a game system 10 of one embodiment of the present invention.

1.1 Structure of the Game System 10

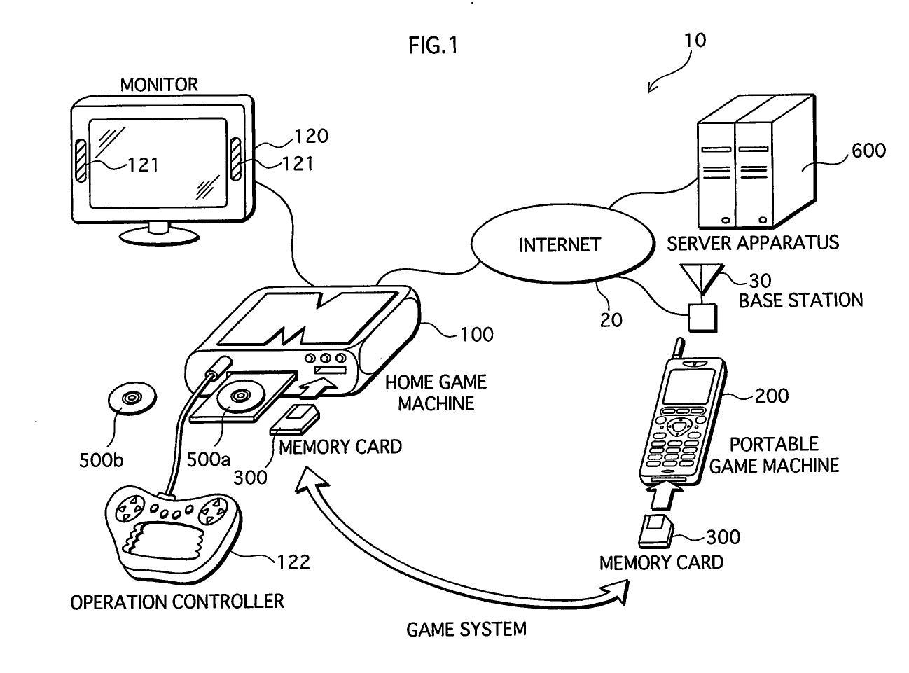

The game system 10, as shown in FIG. 1, is composed of a home game machine 100, a portable game machine 200, a memory card 300, DVDs (digital versatile discs) 500a and 500b, and a server apparatus 600.

The DVD 500a has recorded thereon a home basic program 501a that is a game program executed by a home game machine, a portable basic program 502a that is a game program executed by a portable game machine, general image data 503a that is made up of 3-D curved data, and a serial ID 520a that identifies the game software. The DVD 500b has recorded thereon a home basic program 501b, general image data 503b, and a serial ID 520b.

Here, the game executed according to the home basic program and the game executed according to the portable basic program are the same game.

A user mounts the DVD 500a or the DVD 500b in the home game machine 100, and also mounts the memory card 300 in the home game machine 100.

When executing the game according to user operations, the home game machine 100 generates home image data compatible with the home game machine from the general image data, and executes the game while displaying the generated home image data.

The general data is 3D curve data that expresses the 3D shape of each object. The home image data is 3D polygon data that expresses the 3D shape of each object.

(1) When the DVD 500a is Mounted

When the user quits the game, the home game machine 100 writes the portable basic program and save data to the memory card 300.

Next, according to a user operation, the portable game machine 200 reads the portable basic program from the memory card 300, and executes the game.

The portable game machine 200 and the home game machine 100 are connected over the Internet 20, and the home game machine 100 transmits portable image data that has been generated from the general image data to be suitable for the portable game machine 200, to the portable game machine 200.

The portable game machine 200 receives the portable image data, and executes the game while displaying the received portable image data.

In this way, the user is able to enjoy the same game on both the home game machine 100 and the portable game machine with images of image quality suitable for the respective game machine.

(2) When the DVD 500b is Mounted

When the user quits the game, the home game machine 100 writes save data to the memory card 300.

Instead of writing the portable basic program to the memory card 300 in the home game machine 100, while the memory card 300 is mounted, the portable game machine 200 receives the portable basic program from the server apparatus 600 over the Internet 20, and writes the received portable basic program to the memory card 300.

Next, according to a user operation, the portable game machine reads the mobile basic program from the memory card 300, and executes the game.

The portable game machine 200 and the home game machine 100 are connected over the Internet 20, and the home game machine 100 transmits portable image data that has been generated from the general image data to be suitable for the portable game machine 200, to the portable game machine 200 over the Internet 20 as necessary.

The portable game machine 200 receives the portable image data, and executes the game while displaying the received portable image data.

1.2 DVD 500a and DVD 500b

The DVD 500a and the DVD 500b are portable optical disc media on which a large amount of data can be recorded.

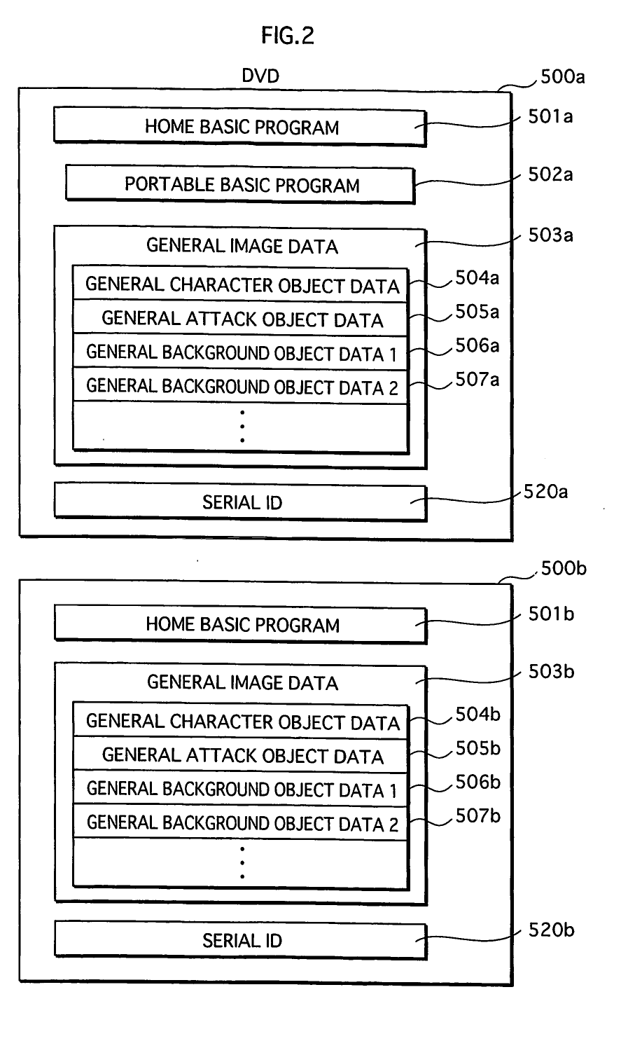

As one example, as shown in FIG. 2, the DVD 500a has recorded thereon the home basic program 501a, the portable basic program 502a, the general image data 503a, and the serial ID 520a. These are computer programs and computer data used in the home game machine 100, and together compose one game software.

The DVD 500b has recorded thereon a home basic program 501b, general image data 503b, and a serial ID 520b. These are a computer program and computer data used in the home game machine 100 and the portable game machine 200, and together compose one game software.

(1) Description of the Game

The following describes the game of the home basic program 501a and the general image data 503a stored on the DVD 500a. The game of the portable basic program 502a and the general image data 503a, and the game of the home basic program 501b and the general image data 503b are identical to that of the home basic program 501a and the general image data 503a, and therefore a description thereof is omitted.

The game is composed of n successive game stages 1, 2, n, and the game progresses in the stated order of game stages. Each game stage is composed of m successive game steps 1, 2, . . . , m, and the game progresses in the stated order of game steps.

The time for which the user plays the game in each game step (hereinafter called “play time”) is limited to a maximum value MAX. When the play time in a game stage exceeds the maximum value MAX, the game step ends normally at that point, and the game proceeds to the next game step.

One or more characters, backgrounds, attackers, and other objects appear in the game. The characters are targets of operations by a player, in other words, by a user of the home game machine 100. The backgrounds express the scenes in the game. The attackers attack the characters.

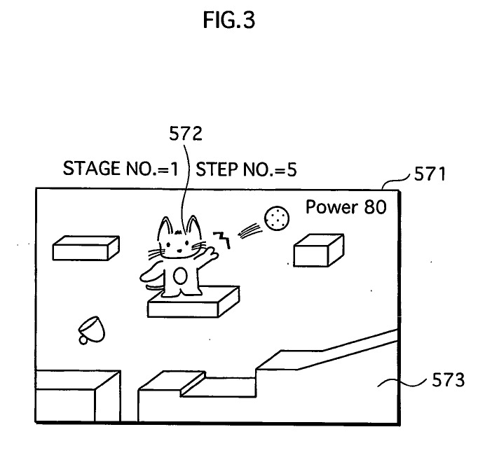

FIGS. 3 to 5 shows examples of screens displayed on a monitor 120 in various game steps of game stages.

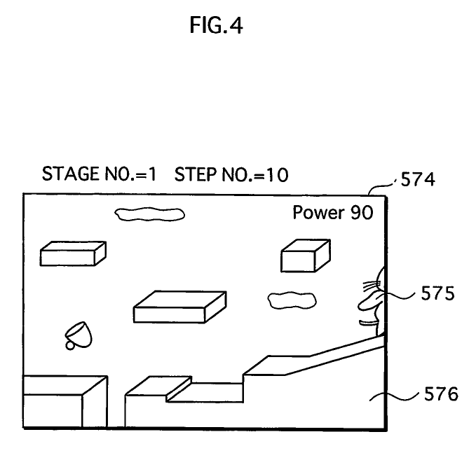

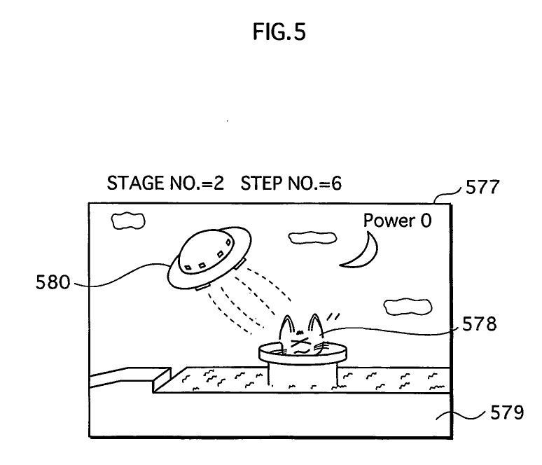

In a screen 571 shown in FIG. 3, a character 572, a background 573, and other objects are displayed. In a screen 574 shown in FIG. 4, a character 575, a background 576, and other objects are displayed. Furthermore, in a screen 577 shown in FIG. 5, a character 578, a background 579, an attacker 580, and other objects are displayed.

Each character is given characteristic properties including a species, a sex, and an occupation, form properties including a height, a weight, a hairstyle, an eye shape, and an ear shape, and ability properties such as a life power, a fighting power, and money.

The species, sex, occupation hairstyle, eye shape, and ear shape are properties that do not change, whereas the height, weight, life power, fighting power, and money are properties that change as the game progresses. The following describes information that expresses these properties. Hereinafter this information referred to in a general sense as character data.

Here, the character, attackers, and backgrounds exist virtually in a 3D game space. The game space is expressed by orthogonal coordinates, each consisting of an X coordinate, a Y coordinate, and a Z coordinate.

A display space is generated by clipping part of the game space, and characters and the like that exist in the display space are projected on the frame, thereby forming an image.

(2) Home Basic Programs 501a and 501b

The home basic program 501a includes a home game computer program (hereinafter called a home main program), a computer program for processing one frame of an image (hereinafter called a home frame processing program), and home image generation program for generating images of objects from home image data which is described later.

Each computer program is composed of a plurality of machine language instructions. The machine language is of a format that is able to be decoded and executed by a main control unit 108 (described later) and a graphic control unit 113 (described later) of the home game machine 100. The home main program and the home frame processing program are used by the main control unit 108, and the home image generation program is used by the graphic control unit 113.

The home basic programs 501a and 501b are identical programs, and therefore a description of the home basic program 501b is omitted.

The following describes the computer programs. For ease of comprehension, the contents of the computer programs are expressed according to flowcharts that show operations of the home game machine 100 when executing the computer programs, rather than with reference to machine language instructions, and the descriptions are given using the flowcharts.

Note that the components of the home game machine 100 are described later.

(a) Home Main Program

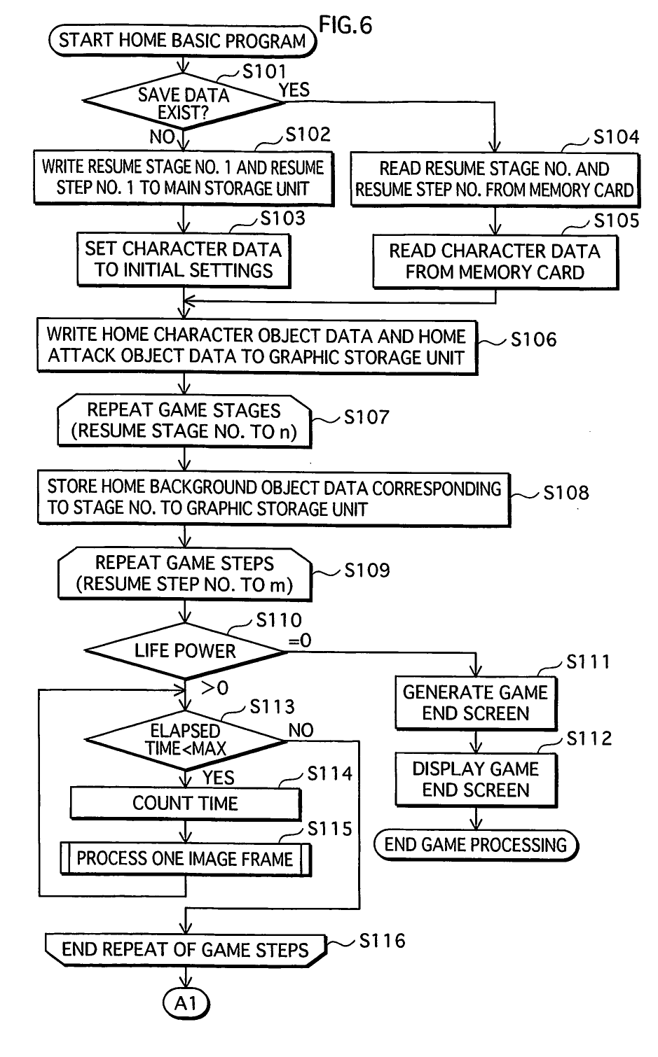

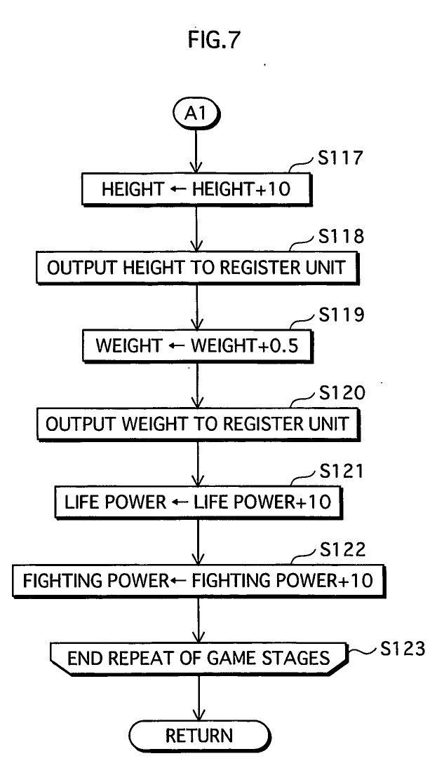

The following describes the home main program with use of the flowcharts in FIG. 6 and FIG. 7.

The main control unit 108 checks whether or not save data is stored in the information storage unit 301 of the memory card 300 (step S101), and when save data is not stored (step S101), writes resume stage No. “1” and resume step No. “1” to the main memory unit 110 (step S102). The main control unit 108 then sets the initial values of the character data set in advance in the home main program, and writes the initial values to the main memory unit 110 (step 103). Specifically, the initial values are a height of 20 cm, a weight of 10 kg, a life power of 100, and a fighting power of 100, which are the form properties and ability properties given to the character when the game is executed from the start.

Here, the resume stage No. and the resume step No. are numbers indicating the game stage and the game step from which the game resumes. When both the resume stage No. and the resume step No. are both “1”, the game is executed from the first game step of the first game stage. If, for example, the resume stage No. is “5” and the resume step No. “3”, the game is executed from the third game step of the fifth game stage. In this way, the resume stage No. and the resume step No. are information for controlling the position (game stage and game step) at which to commence execution of the game.

When save data is stored in the memory card 300 (step S101), the main control unit 108 reads the resume step No. 331 and the resume stage No. 332 from the memory card 300, and writes the read resume step No. 331 and resume stage No. 332 to the main storage unit 110 (step S104).

Next, the main control unit 108 reads the character data 333 from the memory card 300, and writes the read character data 333 to the main storage unit 110 (step S105).

Here, n pieces of general background object data exist, and correspond one-to-one to the successive game stages 1, 2, . . . , n. Furthermore, n pieces of home background object data and n pieces of portable background object data also exist, and these also correspond one-to-one to the game stages.

Next, the main control unit 108 reads the home character object data and the home attacker object data from the main storage unit 110, and writes the read home character object data and attacker object data to the graphic storage unit 114 (step S106).

Next, at step S107 to step S123, the following steps S108 to S122 are repeated from the resume stage No. until the game stage indicated by “n” ends.

(i) The main control unit 108 reads the piece of home background data corresponding to the resume stage No. from the main storage unit 110, and writes the read piece of home background object data to the graphic storage unit 114 (step S108).

(ii) At steps S109 to S116, the main control unit 108 repeats the following steps S110 to S115 from the resume game step No. until the game step indicated by “m” ends.

The main control unit 108 judges whether or not the life power of the character is “0” (step S109).

When the life power is judged to be “0” (step S110), the main control unit 108 generates a screen that indicates the end of the game, and writes the generated screen to the frame buffer 106 as a frame image (step S111). The main control unit 108 then writes, to the register R0 151 in the register unit 109, a screen display instruction indicating transfer of a frame image in the frame buffer 106 to the VRAM 115, and outputs a control signal indicating that an instruction has been written to the register unit 109, to the graphic control unit 113 (step S112). The main control unit 108 then ends the processing.

When the life power is judged not to be “0” (step S110), the main control unit 108 judges whether elapsed time in the game stage has exceeded the maximum value MAX (step S113), and when it is judged that the elapsed time has exceeded the maximum value MAX (step S113), ends the game step and proceeds to the next game step.

When the elapsed time is judged not to have exceeded the maximum value MAX (step S113), the main control unit 108 counts time (step S114), invokes the home frame processing program, and by moving control to the home frame processing program, processes one image frame (step S115). After processing of one image frame has ended, the main control unit 108 returns to step S113 and repeats the processing.

(iii) Next, the main control unit adds a value “10” to the height written in the main storage unit 110 (step S117), and writes the newly obtained height to the highest bit in a register R4 155 in the register unit 109 (step S118).

The main control unit 108 adds a value “0.5” to the weight written in the main storage unit 110 (step S119), and writes the newly obtained height to the lowest bit in the register R4 155 in the register unit 109 (step S120).

The main control unit 108 adds “10” to the life power written in the main storage unit 110 (step S121).

The main control unit 108 adds “10” to the fighting power written in the main storage unit 110 (step S122).

(b) Home Frame Processing Program

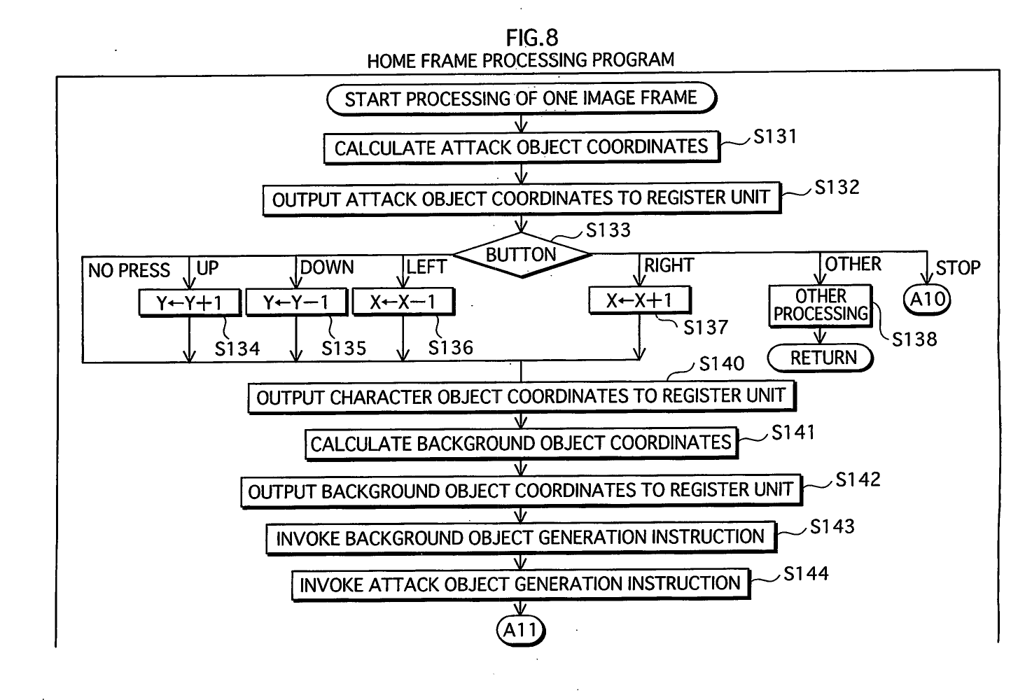

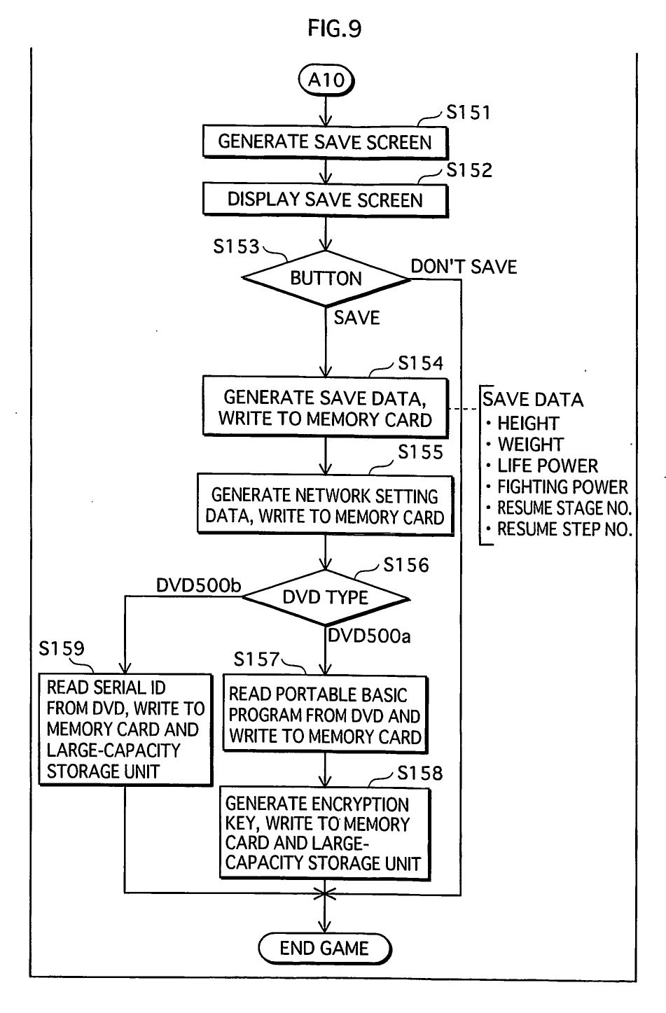

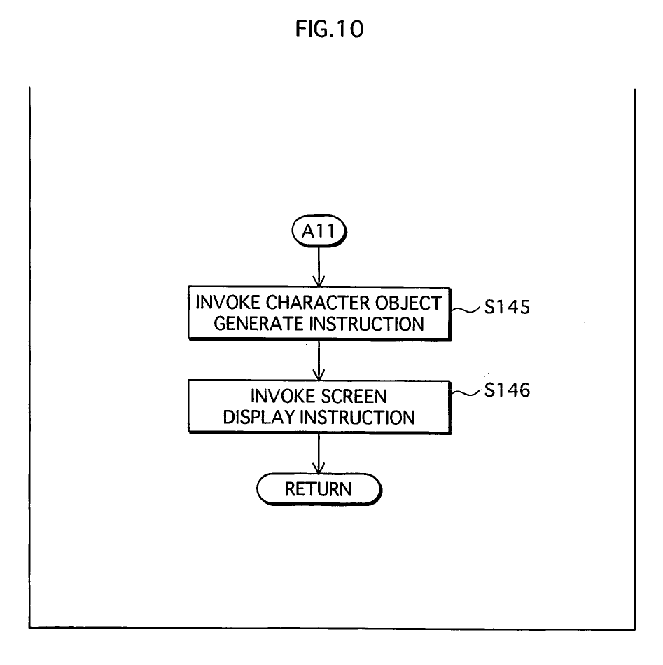

The following describes the home frame processing program with use of the flowcharts shown in FIG. 8 to FIG. 10.

The main control unit 108 calculates the present coordinate values (3D coordinates) of an attack object in the game space (step S131). Here, the attack object coordinates are those of a central point of the shape of the attack object (for example, a central point of the head in the case of an object representing a person). Note that this is the same for coordinate values of a character object and coordinate values of a background object.

More specifically, the main control unit 108 calculates the coordinate values of the attack object in the following way.

The initial values of the coordinates of the attack object are described in the frame processing program. First, these initial values are used for the coordinate values of the attack object.

The main control unit 108 then generates three random numbers (corresponding to the X coordinate value, the Y coordinate value, and the Z coordinate value), and by adding these three random numbers to the respective coordinate values of the attack object (the X coordinate value, the Y coordinate value, and the Z coordinate value), newly calculates coordinate values of the attack object (step 131).

Next, the main control unit 108 writes the calculated coordinate values of the attack object to a register R3 154 in the register unit 109 (step S132).

Next, the main control unit 108 receives operation instruction information corresponding to a button on the operation controller 122, from the operation controller 122 over the controller control unit 101, and determines the type of the received operation instruction information (step S133).

When the received operation instruction information corresponds to an up button, a down button, a left button or a right button (step S133), the main control unit 108 adds “1” to the Y coordinate value (step S134), subtracts “1” from the Y coordinate value (step S135), subtracts “1” from the X coordinate value (step S136), or adds “1” to the Y coordinate value (step S137), respectively.

Here, the initial coordinate values of the character object are described in the home frame processing program in the same manner as the initial coordinate values of the attack object. These initial coordinate values are used as the coordinate values of the coordinates of the character object at first.

When the received operation instruction information corresponds to a stop button (step S133), control moves to step S151.

When the received operation instruction information corresponds to another button (step S133), the main control unit 108 performs corresponding processing (step S138), and then ends the home frame processing program.

When no operation instruction information is received (step S133), the main control unit 108 moves to step S140 without performing any processing.

Next, the main control unit 108 writes the coordinate values of the character object to a register R1 152 in the register unit 109 (step S140).

The main control unit 108 calculates the coordinate values of the background object (step S141), and writes the calculated background coordinate values to a register R2 153 in the register unit 109 (step S142).

Next, the main control unit 108 invokes a background object generate instruction. Specifically, the home main program writes a generate instruction indicating generation of a background object to the register R0 151 in the register unit 109, and outputs a control signal to the graphic control unit 113 indicating that an instruction has been written to the register unit 109 (step S143).

Next, the main control unit 108 invokes an attack object generate instruction. Specifically, the main control unit 108 writes a generate instruction indicating generation of an attack object to the register R0 151 of the register unit 109, and outputs a control signal to the graphic control unit 113 indicating that an instruction has been written to the register unit 109 (step S144).

Next, the main control unit 108 invokes a character object generate instruction. Specifically, the main control unit 108 writes a generate instruction indicating generation of a character object to the register R0 151 of the register unit 109, and outputs a control signal to the graphic control unit 113 indicating that an instruction has-been written to the register unit 109 (step S145).

Next, the main control unit 108 writes, to the register R0 151 in the register unit 109, a screen display instruction indicating transfer of the frame image in the frame buffer 106 to the VRAM 115, and outputs a control signal to the graphic control unit 113 indicating that a instruction has been written to the register unit 109 (step S146). Next, the main control unit 108 ends the home frame processing program.

When the received operation instruction information corresponds to the step button (step S133), before ending the game, the main control unit 108 generates a save screen that includes a message for checking with the player whether to end the game after saving the character data, the resume stage No., and the resume step No. to the memory card 300, or whether to end the game without saving these. The main control unit 108 saves the generated save screen to the frame buffer 106 as a frame image (step S151). Next, the main control unit 108 writes a screen display instruction indicating transfer of the frame image in the frame buffer 106 to the VRAM 115, to the register R0 151 in the register unit 109, and outputs a control signal to the graphic control unit 113 indicating that an instruction has been written to the register unit 109 (step S152).

Next, the main control unit 108 receives operation instruction information corresponding to a button on the operation controller 122 from the operation controller 122 via the controller control unit 101. Here, the operation instruction information indicates where to save the character data, the resume stage No., and the resume step No. Next, the main control unit 108 determines the type of the received operation instruction information (step S153).

When the received operation instruction information indicates that the character data, the resume stage No., and the resume step No. are not to be saved (step S147), the game processing ends.

When the received operation instruction information indicates that the character data, the resume stage No., and the resume step No. are to be saved (step S153), the main control unit 108 reads the character data 133, the resume stage No., and the resume step No. from the main storage unit 110, writes the read character data 133, start storage No., and resume step No. to the information storage unit 301 of the memory card 300 (step S154).

Next, according to an instruction from the main control unit 108, the network setting data unit 119 reads network setting data of the home game machine from the communication unit 104, and writes the read network setting data to the memory card 300. Here, the network setting data is, specifically, an IP address of the home game machine 100 (step S155).

Next, the main control unit 108 judges whether the DVD mounted in the home game machine 100 is the DVD 500a or the DVD 500b, by checking whether or not the portable basic program is recorded on the mounted DVD (step S156).

(i) When the DVD 500a is Mounted

The main control unit 108 reads the portable basic program 502a from the DVD 500a, and records the read portable basic program 502a to the memory card 300.

Next, according to an instruction from the main control unit 108, the key generation unit 105 generates an encryption key, and records the encryption key to the large-capacity storage unit 111 and the memory card 300 (step S158).

The home frame processing program processing then ends.

(ii) When the DVD 500b is Mounted

The main control unit 108 reads the serial ID 520b from the DVD 500b, and writes the read serial ID 520b to the memory card 300 and the large-capacity storage unit 111 (step S159).

The home frame processing program processing then ends.

(c) Home Image Generation Program

The home image generation program is a computer program composed of a plurality of machine language instructions. The machine language is of a format that is able to be decoded and executed by the graphic control unit 113 (described later) of the home game machine 100. The home image generation program is used by the graphic control unit 113.

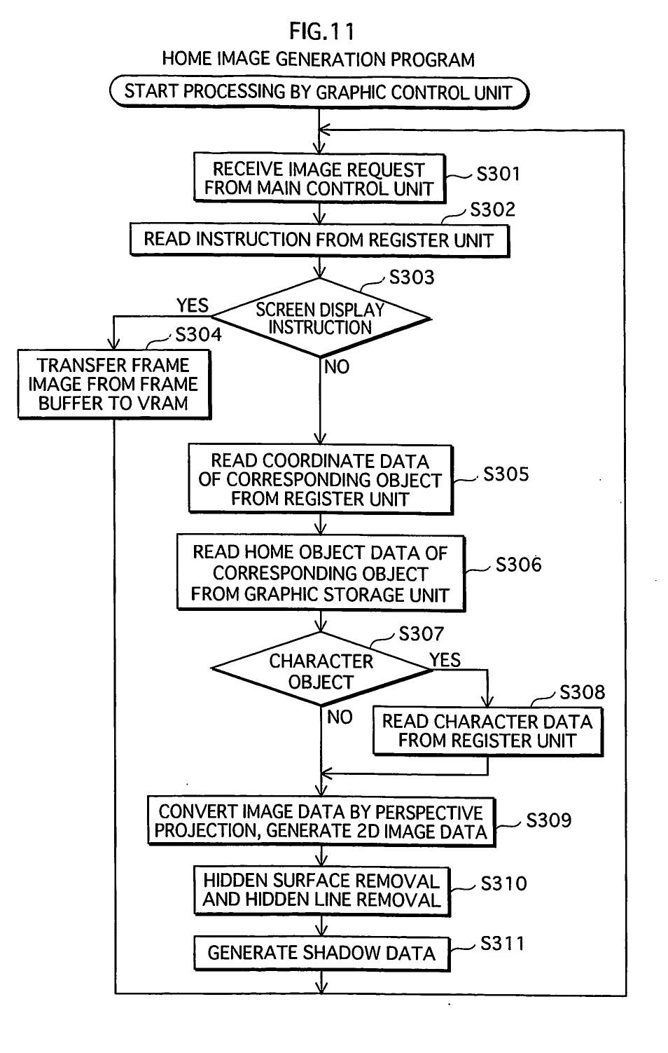

The following describes the home image generation program. For ease of comprehension, the contents of the home image generation program are expressed according to the flowchart in FIG. 11 rather than with reference to machine language instructions, and the descriptions are given using this flowchart.

The graphic control unit 113 receives a control signal from the main control unit 108 indicating that an instruction has been written to the register unit 109. This control signal indicates a request from the main control unit 108 to the graphic control unit 113 to generate an image (step S301).

On receiving the control signal, the graphic control unit 113 reads the contents of the register R0 151 in the register unit 109. A instruction has been written to the register R0 151 by the main control unit 108 (step S302).

Next, the graphic control unit 113 determines whether or not the read content, in other words the instruction, is a screen display instruction (step S303). When the instruction is a screen display instruction (step S303), the graphic control unit 113 transfers a frame image, which has been stored in the frame buffer 106 of the home game machine 100 during a vertical retrace period described later, to the VRAM 115 (step S304). Next, the graphic control unit 113 returns to step S301 and repeats the processing.

When the instruction is determined not to be a screen display instruction (step S303), in other words when the instruction is a character object generation instruction, a background object generation instruction, or an attack object generation instruction, the graphic control unit 113 reads the coordinates of the object that is the target of the object generation instruction from the register unit 109. In other words, the graphic control unit 113 reads the contents of the register R1 152 when the generation instruction is for a character object, the contents of the register R2 153 when the generation instruction is for a background object, and the contents of the register R3 154 when the generation instruction is for an attack object (step S305). Hereinafter, home character object data, home attack object data, and home background data are referred to in a general sense as home object data.

Next, the graphic control unit 113 reads the home object data of the corresponding object from the graphic storage unit 114 of the home game machine 100 (step S306).

Here, when the corresponding object is a character object (step S307), the graphic control unit 113 reads the height and weight from the register R4 155 in the register unit 109 (step S308).

Next, the graphic control unit 113 converts the home object data of each object according to perspective projection, to generate 2D image data (step S309), applies hidden surface removal and hidden line removal (step S310), and further generates shadow data (step S311). Next, the graphic control unit 113 then returns to step S301 and repeats the processing.

Note that details of hidden surface removal, hidden line removal, and shadow generation are described in Non-Patent Document 2 and Non-Patent Document 3. Since these techniques are commonly known, a description thereof is omitted here.

(3) Portable Basic Program 502a

The portable basic program 502a includes a portable-use game (hereinafter called a portable main program), a computer program for processing an image of one frame (hereinafter called a portable frame processing program), and a portable image generation program for generating images of objects from portable image data which is described later.

The following describes the computer programs. For ease of comprehension, the contents of the computer programs are expressed according to flowcharts that show operations of the portable game machine 200 when executing the computer programs, rather than with reference to machine language instructions, and the descriptions are given using the flowcharts.

Note that the components of the mobile game machine 200 are described later.

(a) Portable Main Program

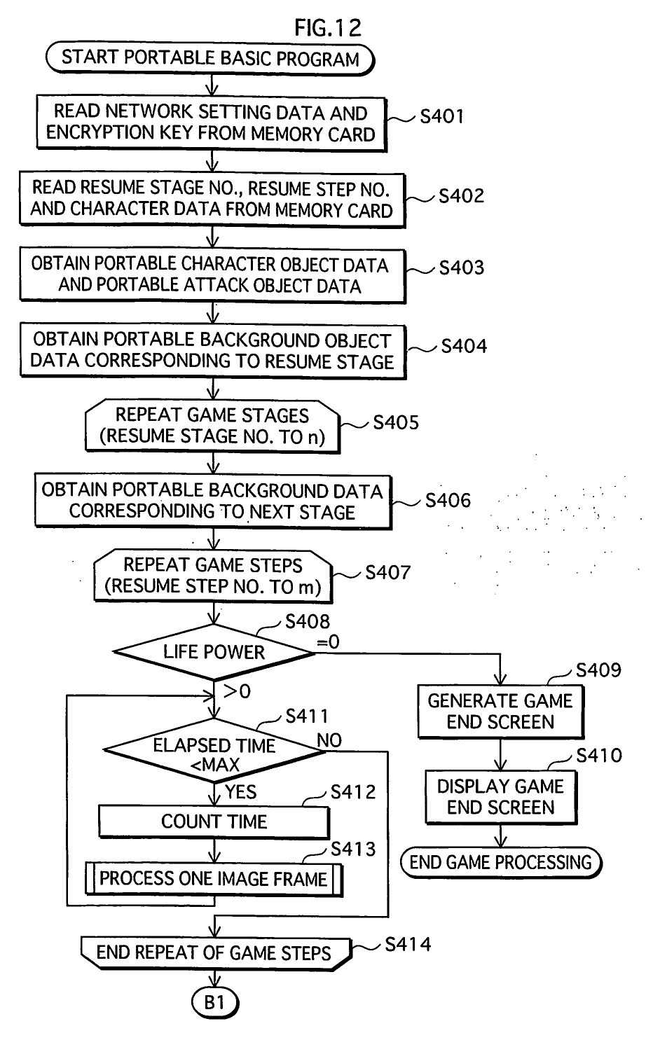

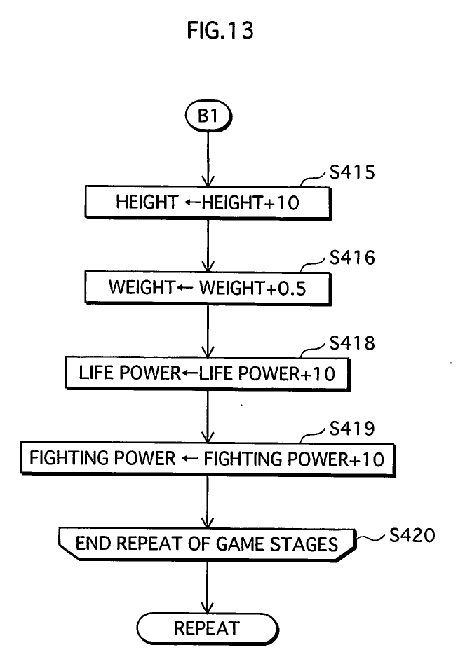

The following describes the portable main program with use of the flowcharts shown in FIG. 12 and FIG. 13.

Note that since the portable main program is similar to the home main program shown in FIG. 6 and FIG. 7, the following description is relatively brief.

The main control unit 208 reads the network setting data and the encryption key from the memory card 300, writes the read network setting data and encryption key to the main storage unit 210, and outputs the IP address to the communication unit 203 (step S401).

Next, the main control unit 208 reads the resume stage No., the resume step No., and the character data from the memory card 300, and writes the read resume stage No., resume step No., and character data to the main storage unit 210 (step S402).

Next, the main control unit 208 obtains portable character object data and portable attack object data over the Internet 20 and the decryption unit 205 (step S403).

Next, the main control unit 208 obtains portable background object data corresponding to the resume stage No. over the Internet 20 and the decryption unit 205 (step S404).

Next, at step S405 to step S420, the main control unit 208 performs the following steps S406 to S419 from the game stage No. indicated by the resume stage No., until the game stage indicated by “n” ends.

(i) In order to perform image processing quickly and ensure that the game progresses smoothly, the main control unit 208 obtains portable background object data corresponding to the next game stage in advance (step S406).

(ii) At step S407 to step S414, the main control unit 208 performs the following steps S408 to S413 from the resume step No. until the game step indicated by “m”.

The main control unit 208 judges whether or not the life power written in the main storage unit 210 is “0” (step S408).

When the life power is judged to be “0” (step S408), the main control unit 208 generates a screen indicating the end of the game, writes the generated screen to a frame buffer in the main storage unit 210 as a frame image (step S409), and, during the vertical retrace period, transfers the frame image in the frame buffer to the VRAM 215 (step S410). The main control unit 208 then ends the game.

When the life power is judged not to be “0” (step S408), the main control unit 208 judges whether or not the elapsed time in the game stage has exceeded the maximum value MAX (step S411), and when the elapsed time is judged to have exceeded the maximum value MAX (step S411), ends the game step and proceeds to the next game step.

When the elapsed time is judged not to have exceeded the maximum value MAX (step S411), the main control unit 208 counts time (step S412), invokes the portable frame processing program, and by moving control to the home frame processing program, processes one image frame (step S413). After processing of one image frame has ended, the main control unit 208 returns to step S411 and repeats the processing.

(iii) The main control unit 208 adds a value “10” to the height written in the main storage unit 210 (step S415), adds a value “0.5” to the weight written in the main storage unit 210 (step S416), adds a value “10” to the life power written in the main storage unit 210 (step S419), and adds a value “10” to the fighting power written in the main storage unit 210 (step S420).

(b) Portable Frame Processing Program

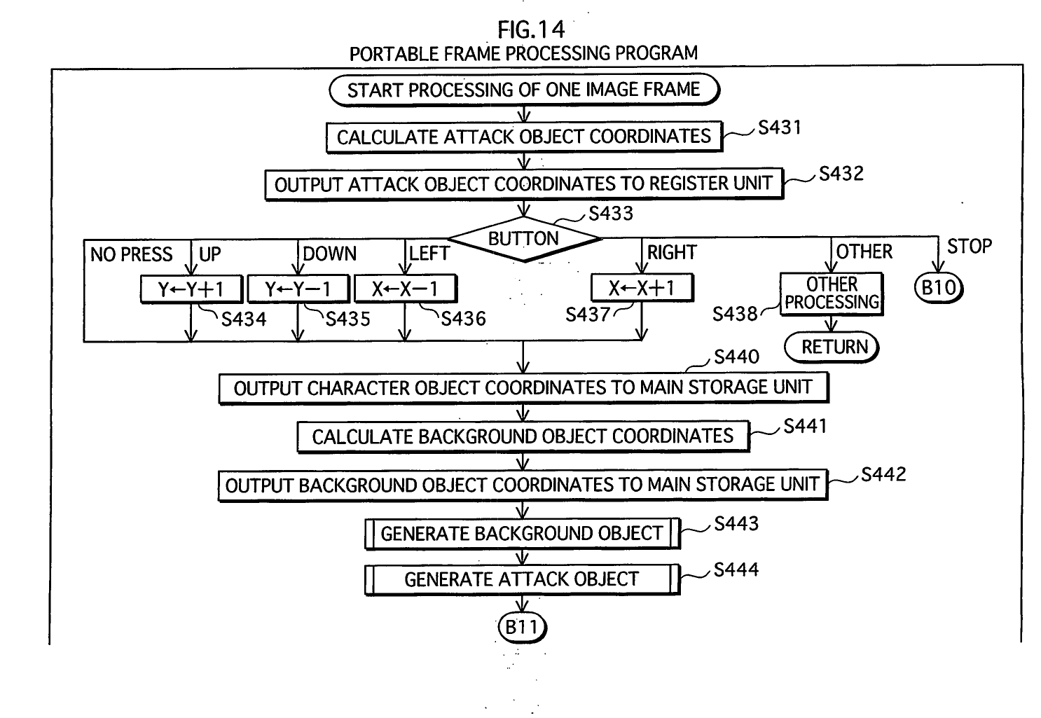

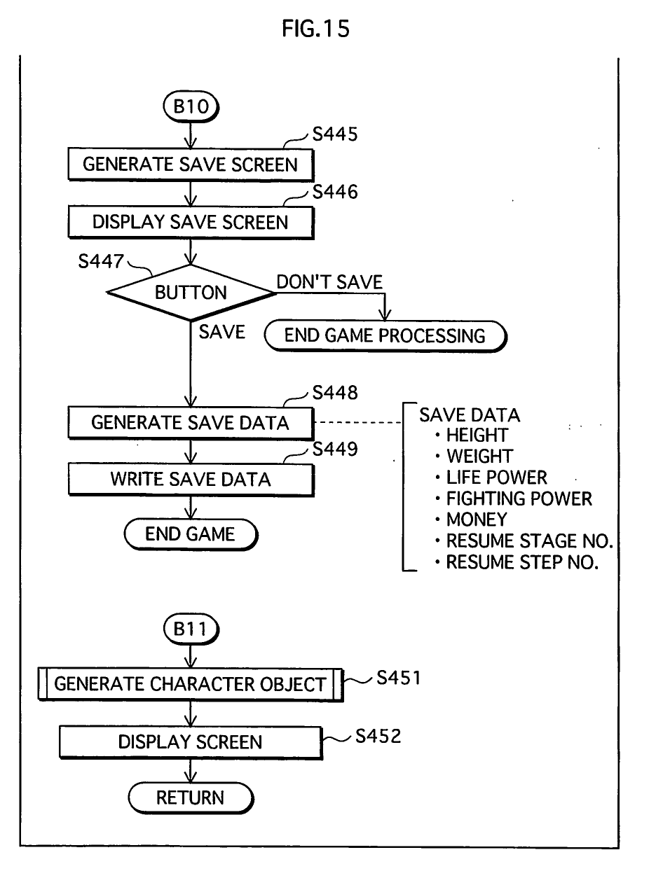

The following describes the portable frame processing program with use of the flowcharts shown in FIG. 14 and FIG. 15.

Note that since the portable frame processing program is similar to the home frame processing program shown in FIG. 8 to FIG. 10, the following description is relatively brief.

The main control unit 208 calculates the coordinate values (3D coordinates) of an attack object in the game space at the present point in time (step S431).

Next, the main control unit 208 writes the calculated coordinate values of the attack object to the main storage unit 210 (step S432).

Next, the main control unit 208 receives operation instruction information corresponding to a button from the input unit 201, and determines the type of the received operation instruction information (step S433).

When the received operation instruction information corresponds to an up button, a down button, a left button or a right button (step S433), the main control unit 208 adds “1” to the Y coordinate value (step S434), subtracts “1” from the Y coordinate value (step S435), subtracts “1” from the X coordinate value (step S436), or adds “1” to the Y coordinate value (step S437), respectively.

When the received operation instruction information corresponds to the stop button (step S433), the main control unit 208 moves control to step S445.

When the received operation instruction information corresponds to another button (step S433), the main control unit 208 performs corresponding processing (step S438), and then ends.

When no operation instruction information is received (step S433), the main control unit 208 moves control to step S440 without performing any processing.

Next, the main control unit 208 writes the coordinate values of the character object to the main storage unit 210 (step S440).

The main control unit 208 calculates the coordinate values of the background object (step S441), and writes the calculated background coordinate values to the main storage unit 210 (step S442).

Next, the main control unit 208 designates a background object and invokes the portable image generation program (step S443), designates an attack object and invokes the portable image generation program (step S444), and designates a character object and invokes the portable image generation program (step S451).

Next, in the vertical retrace period, the main control unit 208 transfers the frame image in the frame buffer in the main storage unit 210 to the VRAM 215 (step S452). The main control unit 208 unit then ends the processing.

When the received operation instruction information corresponds to the stop button (step S433), before ending the game, the main control unit 208 generates a save screen that includes a message for checking with the player whether to end the game after saving the character data, the resume stage No., and the resume step No. to the memory card 300, or whether to end the game without saving these. The main control unit 208 saves the generated save screen to the main storage unit 210 as a frame image (step S445). Next, during the vertical retrace period, the main control unit 208 transfers the frame image in the frame buffer to the VRAM 215 (step S446).

Next, the main control unit 208 receives operation instruction information corresponding to a button from the input unit 201. Here, the operation instruction information indicates whether or not to save the character data, the resume stage No., and the resume step No. The main control unit 208 determines the type of the received instruction information (step S447).

When the received operation instruction information indicates that the character data, the resume stage No., and the resume step No. are not to be saved (step S447), the game processing ends.

When the received operation instruction information indicates that the character data, the resume stage No., and the resume step No. are to be saved (step S447), the main control unit 208 reads the character data from the main storage unit 210 (step S448), and overwrites the character data 333 in the information storage unit 301 of the memory card 300 (step S449). The portable frame processing program processing then ends.

(c) Portable Image Generation Program

The main control unit 208 reads the coordinates of the object to be generated, from the main storage unit 210 (step S464). Hereinafter, portable character object data, portable attack object data, and portable background data are referred to in a general sense as portable object data.

Next, the main control unit 208 reads the corresponding portable object data from the main storage unit 210 (step S465).

Here, when the corresponding object is a character object (step S466), the portable image generation program reads the height and the weight from the main storage unit 210 (step S467).

Next, the main control unit 208 subjects the portable object data to perspective projection to generate 2D image data (step S471), applies hidden surface removal and hidden line removal (step S473), and generates shadow data (step S474).

(4) General Image Data 503a and 503b

The general image data 503a, as shown in FIG. 2, is composed of general character object data 504a, general attack object data 505a, general background object data 506a, general background object data 507a, and so on.

The general character object data 504a, the general attack object data 505a, the general background object data 506a, the general background object data 507a, and so on correspond to a character object, an attack object, a background object, and so on of the game of the home basic program 501a and the portable basic program 502a.

The general character object data 504a, the general attack object data 505a, the general background object data 506a, the general background object data 507a, and so on are 3D curved surface data and curved line data expressing, respectively, a character object, an attack object, background objects, and so on.

As one example, the three dimensional curves and the three dimensional surfaces are Bezier curves, Bezier surfaces, and bi-cubic B-Spline surfaces, and soon, defined by a plurality of control points and an equation.

Hereinafter, the general object data, the general attack object data, and the general background object data are referred to in general terms as general object data.

Since the general image data 503a and the general object data 503b are identical, a description of the general object data 503b is omitted.

(5) Serial ID 520a and Serial ID 520b

The serial ID 520a and the serial ID 520b are identification information that identify the game software stored on the DVD 500a and the DVD 500b, respectively.

1.3 Home Game Machine 100

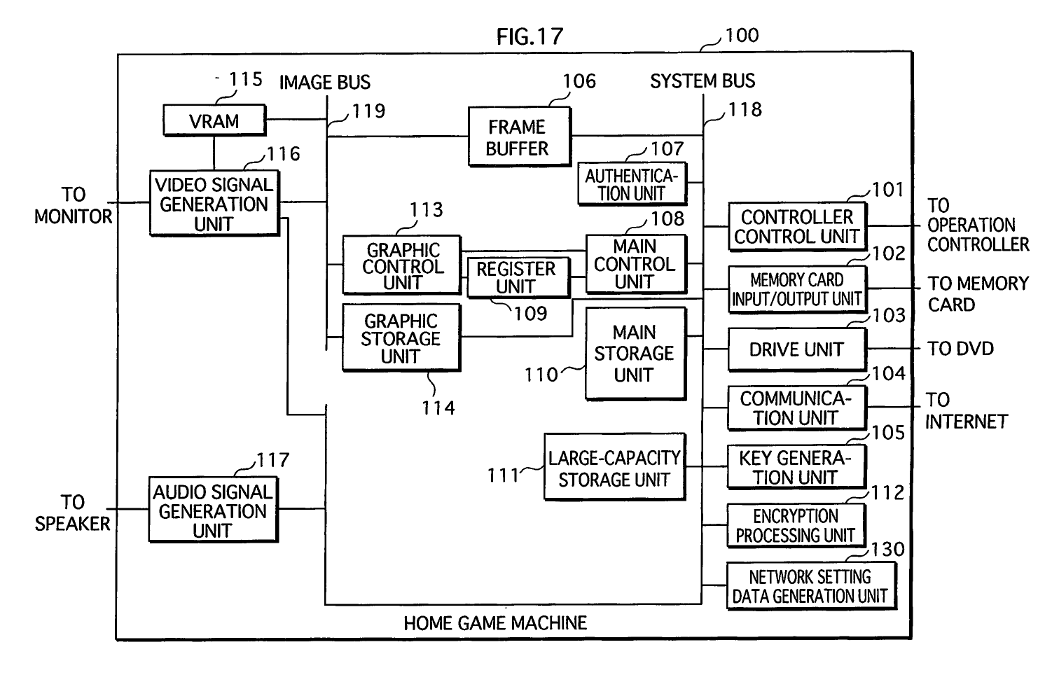

The home game machine 100, as shown in FIG. 17, is composed of a controller control unit 101, a memory card input/output unit 102, a drive unit 103, a communication unit 104, a key generation unit 105, a frame buffer 106, an authentication unit 107, a main control unit 108, a register unit 109, a main storage unit 110, a large-capacity storage unit 111, a graphic control unit 113, a graphic storage unit 114, a VRAM 115, an image signal processing unit 116, an audio signal processing unit 117, a system bus 118, an image bus 119, an encryption processing unit 112, and a network setting data generation unit 130.

The controller control unit 101, the memory card input/output unit 102, the drive unit 103, the communication unit 104, the key generation unit 105, the frame buffer 106, the authentication unit 107, the main control unit 108, the main storage unit 110, the large-capacity storage unit 111, the graphic storage unit 114, the audio signal generation unit 117, the video signal generation unit 116, the encryption processing unit 112, and the network setting data generation unit 130 are connected to the system bus 118. The frame buffer 106, the graphic control unit 113, the graphic storage unit 114, the VRAM 115, and the video signal generation unit 116 are connected to the image bus 119.

An operation controller 122, and a monitor 120 are connected to the home game machine as shown in FIG. 1. Furthermore, the home game machine 100 is connected to the portable game machine 200 over the Internet 20. The DVD 500a or the DVD 500b, and the memory card 300 are mounted in the home game machine 100.

(1) Operation Controller 122

The operation controller 122 is provided with buttons including an up button, a down button, a left button, a right button, an OK button, a start button, and a stop button, on the front surface thereof. On receiving an operation of any one of the buttons from the user, the operation controller 122 outputs operation instruction information corresponding to the button of which the operation was received, to the home game machine 100.

(2) Controller Control Unit 101, Memory Card Input/Output Unit 102, Drive Unit 103, and Communication Unit 104

The controller control unit 101 is connected to the operation controller 122. The controller control unit 101 receives operation instruction information corresponding to a button from the operation controller 122, and outputs the received operation instruction information to the main control unit 108 via the system bus 118.

Furthermore, the memory card input/output unit 102 is connected to the memory card 300, and, under the control of the main control unit 108, reads information from the memory card 300, and outputs the read information to the main control unit 108 via the system bus 118. The memory card input/output unit 102 also receives information from the main control unit 108 via the system bus 118, and writes the received information to the memory card 300.

The drive unit 103, under the control of the main control unit 108, reads information recoded on either the DVD 500a or the DVD 500b, and outputs the read information to the main control unit 108 via the system bus 118.

The communication unit 104 is connected to the Internet, and performs reception and transmission of information between the main control unit 108 and an external apparatus connected to the Internet 20. Here, the external apparatus is the portable game machine 200.

The communication unit 104 stores it's own IP address.

(3) Monitor 120

The monitor 120 has a built-in a speaker 121. The monitor 120 receives a video signal that includes a vertical retrace period and a horizontal trace period, from the video signal generation unit 116, and displays a video based on the received video signal. The speaker 121 receives an audio signal from the audio signal generation unit 117, converts the received audio signal to audio, and outputs the audio.

(4) Main Storage Unit 110, Large-Capacity Storage Unit 111, and Graphic Storage Unit 114

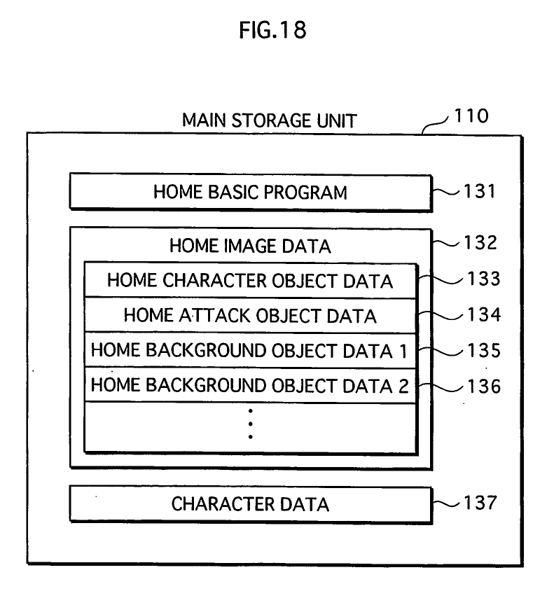

The main storage unit 110 is a RAM (random access memory), and as one example which is shown in FIG. 18, stores information including the home basic program 131, the home image data 132, and the character data 137.

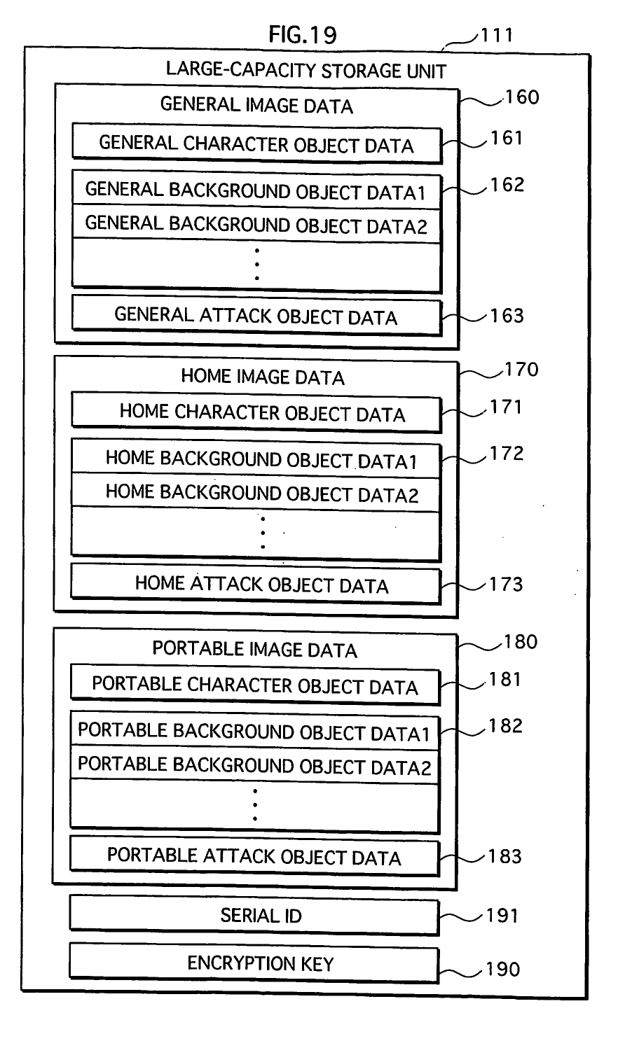

The large-capacity storage unit 111 is a hard disk unit, and as one example which is shown in FIG. 19, general image data 160, home image data 170, portable image data 180, an encryption key 190, a serial ID 191, and so on are written thereto.

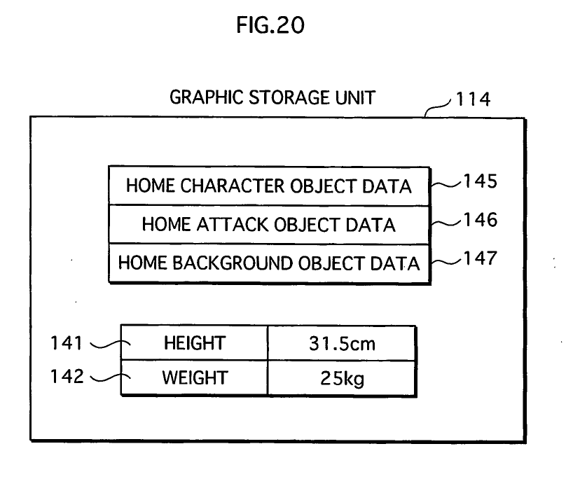

The graphic storage unit 114 is a RAM, and as one example which is shown in FIG. 20, stores home character object data 145, home attack object data 146, home background data 147, and a height 141 and a weight 142 of a character object.

(5) Register Unit 109

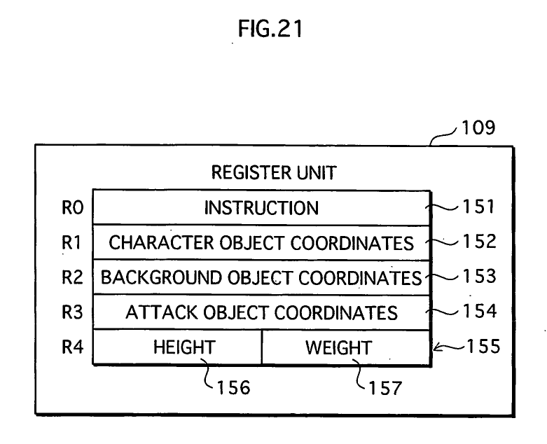

The register unit 109, as shown in FIG. 21, has five registers: a register R0 151, a register R1 152, a register R2 153, a register R3 154, and a register R4 155. Each register has a 128-bit length.

The register unit 109 is connected to both the main control unit 108 and the graphic control unit 113.

The use of each register is determined in advance.

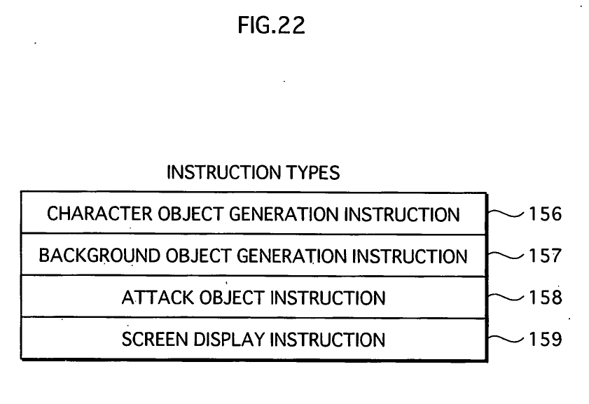

Instructions are stored in the register R0 151 by the main control unit 108. The types of instructions stored in the register R0 151 are shown in FIG. 22. As shown in the drawing, an instruction stored in the register R0 151 is any one of a character object generation instruction 156, a background object generation instruction 157, an attack object generation instruction 158, and a screen display instruction 159.

The character object generation instruction 156, the background object generation instruction 157, and the attack object generation instructions 158 are instructions for instructing generation of an image of a character object, a background object, and an attack object, respectively. The screen display instruction 159 is a instruction for instructing frame data stored in the frame buffer 106 to be transferred to the VRAM 115.

Furthermore, the register R1 152, the register R2 153, and the register R3 154 store character object coordinate values, background object coordinate values, and attack object coordinate values, respectively. Note that the highest 32 bits of each register are used for storing an X coordinate, a Y coordinate, and a Z coordinate.

Furthermore, the highest 64 bits of the register R4 155 are used for storing the height, and the lowest 64 bits are used for storing the weight.

(6) Frame Buffer 106

The frame buffer 106 has an area for storing one frame image. The frame image is a matrix of 256,000 pixels with 640 pixels in the vertical direction and 400 pixels in the horizontal direction.

(7) Authentication Unit 107

Before the main control unit 108 performs communication or transmission/reception of information with either of external apparatuses connected to the home game machine 100, the authentication unit 107 performs mutual challenge-response device authentication with each external apparatus, according to control by the main control unit 108.

Note that since the challenge-response method is commonly known, a description thereof is omitted.

The authentication unit 107 outputs a device authentication result to the main control unit 108. When device authentication fails, the main control unit 108 is prohibited from performing communication and transmission/reception of information with the external apparatus. When device authentication succeeds, the main control unit 108 is permitted to perform communication and transmission/reception of information with the external apparatus.

Here, the external apparatuses are the portable game machine 200 and the memory card 300.

(8) Main Control Unit 108

Specifically, the main control unit 108 is composed of a microprocessor and a RAM (not illustrated). Computer programs are stored in the RAM, the main storage unit 110, or the large-capacity storage unit 111, and the main control unit 108 achieves its functions by the microprocessor operation according to the computer programs.

On receiving operation instruction information corresponding to the start button, the main control unit 108 judges whether game processing is being performed at the time of the operation instruction information being received, and if game processing is not being performed, begins home image conversion processing, and then commences game processing.

When game processing is being performed at the time of the operation instruction information that corresponds to the start button being received, the main control unit 108 stops home image conversion processing and game processing.

Next, the main control unit 108 judges whether or not a request has been received for portable image data, and when such a request has been received, starts portable image conversion processing.

When a request for portable image data is judged not to have been received, the main control unit 108 does not perform portable image conversion processing. Thereinafter, the main control unit 108 repeatedly judges whether input instruction information corresponding to the start button has been received, and whether a request for portable image data has been received.

(i) Game Processing by the Home Game Machine

<Device Authentication>

On receiving input instruction information corresponding to input of the start button from the controller control unit 101, the main control unit 108 controls the authentication unit 107 so as to authenticate whichever of the DVD 500a and the DVD 500b is mounted in the home game machine 100. If authentication succeeds, the main control unit 108 performs game processing which is described later. If authentication fails, the main control unit 108 stops subsequent game processing.

Next, the main control unit 108 controls the authentication unit 107 so as to perform mutual device authentication with the memory card 300. If authentication succeeds, the main control unit 108 performs game processing described below. If authentication fails, the main control unit 108 stops subsequent game processing.

<Home Image Generation Processing>

The main control unit 108 reads the general image data 503a or 503b from the one of the DVD 500a or 500b, and writes the read general image data 503a or 503b to the main storage unit 110 and the large-capacity storage unit 111.

Next, the main control unit 108 generates home image data suitable for the display ability of the home game machine from the general image data stored in the main storage unit 110.

Specifically, the main control unit 108 calculates the coordinates of the surface curves of the general image data that is 3D curved surfaces and 3D curved lines, and converts the general image data into 3D polygon data that is approximated with a 3D multisurface. When calculating the coordinate points of the surface curve, the generated image becomes more precise if the number of control points is increased, and rougher if the number of control points is decreased. Image data suitable for the display ability of the particular game machine is generated by increasing or decreasing the number of control points according to the display ability thereof.

Details of this conversion method are disclosed in Patent Reference 4 and Patent Reference 5, and therefore a description thereof is omitted.

Next, the main control unit 108 writes the generated home image data to the main storage unit 110, and writes the generated home image data to the large-capacity storage unit 111.

After completion of setting of character data at the commencement or resumption of a game according to the procedure shown by the home basic program, the main control unit 108 reads home character object data and home attack object data from the main storage unit 110, and writes the read data to the graphic storage unit 114.

Furthermore, when the game proceeds to a next game stage following the game procedure, the main control unit 108 reads home background object data corresponding to the game stage No. from the main storage unit 110, and writes the read home background object data to the graphic storage unit 114.

<Activation of the Game Program>

The main control unit 108 reads the home basic program 501a or 501b from the mounted DVD 500a or 500b, and writes the read home basic program 501a or 501b to the main storage unit 110.

Next, the main control unit 108 reads save data 330 from the memory card 300, and writes the read save data to the main storage unit 110.

The main control unit 108 fetches one instruction at a time from the home basic program stored in the main storage unit 110, decodes the fetched instruction, and operates according to the decoded instruction. Thereinafter, the main control unit 108 repeatedly fetches, decodes, and executes instructions.

(ii) Processing for Transmitting Portable Object Data to the Portable Game Machine

The main control unit 108 receives a request from the portable game machine 200 over the Internet 20 for encrypted portable character object data, encrypted portable attack object data, or encrypted portable background object data corresponding to the stage No. i (i being an integer from 1 to n). When the received request is for encrypted portable object data, the main control unit 108 checks whether or not portable object data corresponding to the requested encrypted portable object data already exists in the large-capacity storage unit 111, and when such portable object data is judged to exist in the large-capacity storage unit 111, the main control unit 108 reads the portable object data corresponding to the requested encrypted portable object data from the large-capacity storage unit 111, and outputs the read portable object data to the encryption processing unit 112.

When such portable object data is judged not to exist in the large-capacity storage unit 111, the main control unit 108 reads general object data corresponding to the requested encrypted portable object data from the large-capacity storage unit 111, generates portable object data from the read general object data, and writes the generated portable object data to the large-capacity storage unit 111. The main control unit 108 then reads portable object data corresponding to the next requested encrypted portable object data, and outputs the read portable object data to the encryption processing unit 112.

Next, the main control unit 108 checks whether an encryption key is stored in the large-capacity storage unit 111, and when an encryption key is judged to be stored in the large-capacity storage unit 111, the main control unit 108 reads the encryption key 190 from the large-capacity storage unit 111, and outputs the read encryption key 190 to the encryption processing unit 112.

When an encryption key is judged not to be stored in the large-capacity storage unit 111, the main control unit 108 transmits a request over the Internet 20 to the portable game machine 200 to transmit the game machine ID, and obtains the game machine ID. The main control unit 108 outputs the obtained game machine ID and the serial ID stored in the large-capacity storage unit 111 to the key generation unit 105, and requests generation of an encryption key. Next, the main control unit 108 receives the encryption key from the key generation unit 105, and writes the received key to the large-capacity storage unit 111.

The main control unit 108 outputs the received encrypted key to the encryption processing unit 112, requests the encryption processing unit 112 to encrypt the portable object data, and transmits the encrypted portable object data to the portable game machine 200.

Note that processing for generating portable object data is the same as the described processing for generating home image data, with the exception that when calculating the coordinates, the number of control points is reduced to generate image data suitable for the display ability of the portable game machine 200.

(9) Graphic Control Unit 113

Specifically, the graphic control unit 113 is composed of a graphic processor (not illustrated).

The graphic control unit 113 fetches one instruction at a time from the home image processing program, decodes the fetched instruction, and operates according to the decoded instruction. Thereinafter, the graphic control unit 113 repeatedly fetches, decodes, and executes instructions.

(10) VRAM 115

The VRAM 115 has an area for storing one frame image. The frame image is a matrix of 256,000 pixels in a matrix with 640 pixels in the vertical direction and 400 pixels in the horizontal direction. Here, the frame image is the same size as the frame image stored in the frame buffer 106.

(11) Video Signal Generation Unit 116

The video signal generation unit 116 performs the following processing (a) and (b) every 1/60th of a second.

(a) The video signal generation unit 116 generates a vertical synchronization signal, and outputs the vertical synchronization signal to the monitor 120. This period is called a vertical retrace period.

(b) The image signal generation unit 116 performs the following (b1) to (b3) 400 times, in other words, the number of times equal to the number of horizontal pixels in the frame image.

(b1) The image signal generation unit 116 reads one horizontal line of pixels (640 pixels) of the frame image in the VRAM 115.

(b2) The image signal generation unit 116 generates an image signal of one line from the read frame image, and also generates a horizontal synchronization signal.

(b3) The image signal generation unit 116 outputs the generated image signal of the one line and the generated horizontal synchronization signal to the monitor 120.

(12) Audio Signal Generation Unit 117 and Speaker 121

Under the control of the main control unit 108, the audio signal generation unit 117 reads digital audio information from the main storage unit 110, decodes the read audio information, converts the decoded audio information to an analog audio signal, and outputs the analog audio signal to the speaker 121.

The speaker 121 receives the audio signal from the audio signal generation unit 117, converts the received audio signal to audio, and outputs the audio.

(13) Key Generation Unit 105 and Encryption Processing Unit 112

On receiving a request from the main control unit 108 to generate a key, the key generation unit 105 generates an encryption key.

The key generation unit 105 stores a 56-bit long system secret value internally in advance.

On receiving only a request from the main control unit 108 to generate a key, the key generation unit 105 generates a 32-bit random number, and then generates 24-bit date data from the present date and time. The key generation unit 105 then concatenates the generated random number and date data to generate a 56-bit encryption key, and writes the generated encryption key to the large-capacity storage unit 111 and the memory card 300.

When the key generation unit 105 receives a key generation request and a game machine ID from the main control unit 108, the key generation unit 105 concatenates the serial ID and the game machine ID to generate 24-bit ID data, and using the system secret value as a key, subjects the ID data to DES (Data Encryption Standard) encryption processing, and outputs the encrypted ID data to the main control unit 108 as an encryption key.

Note that the method used for generating the key is not limited to the stated method.

The encryption unit 112 receives an encryption processing request and portable image data from the main control unit 108, and applies an encryption algorithm E1 to the portable image data with use of the received encryption key, thereby generating encrypted portable image data.

The encryption processing unit 112 outputs the encrypted portable image data to the communication unit 104.

Here, as one example, the encryption algorithm E1 conforms to DES.

(14) Network Setting Data Generation Unit 130

On receiving a network setting data generation request from the main control unit 108, the network setting data generation unit 130 reads the IP address of the home game machine 100 from the communication unit 104, and writes the read IP address to the memory card 300 as network setting data.

1.5 Memory Card 300

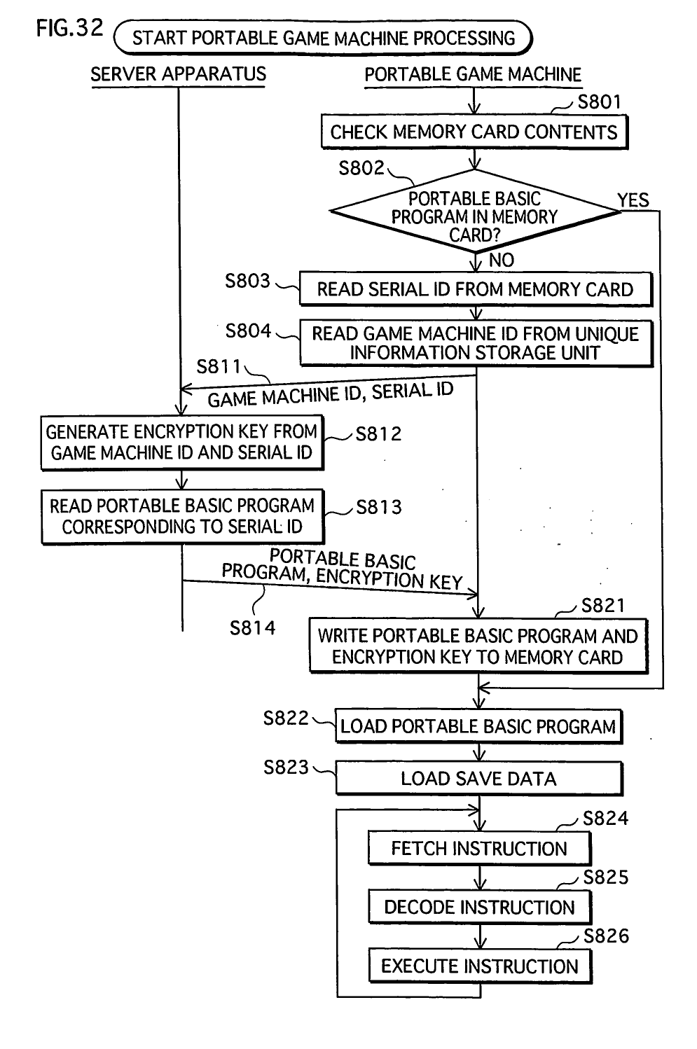

The memory card 300, as shown in FIG. 32, is composed of an information storage unit 301, a control unit 302, an input/output unit 303, and an authentication unit 304.

Specifically, the memory card 300 is a computer system that includes a microprocessor, a ROM, and a RAM. Computer programs are stored in the RAM, and the memory card 300 achieves its functions by the microprocessor operating according to the computer programs.

The memory card 300 is mounted in an external apparatus, receives information from the external apparatus, and stores the received information internally. Furthermore, the memory card 300 reads internally stored information, and outputs the read information to the external apparatus.

Here, the external apparatuses are the home game machine 100 or the portable game machine 200.

(1) Information Storage Unit 301

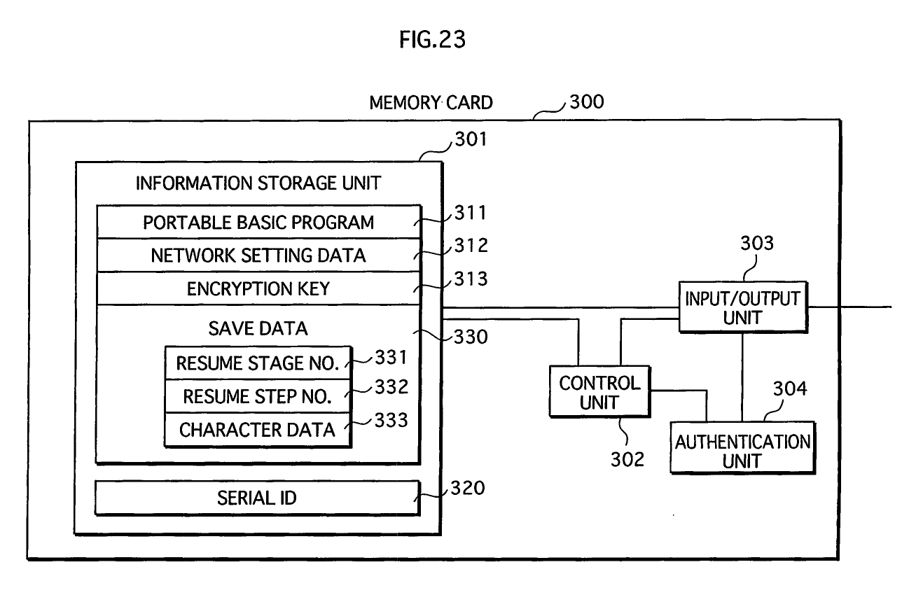

The information storage unit 301, as shown in FIG. 23, stores a portable basic program 311, network setting data 312, an encryption key 313, save data 330, and a serial ID 320.

The save data 330 is composed of a resume state No. 331, a resume step No. 332, and character data 333.

The resume stage No. 331 and the resume step No. 332 are as described earlier, and therefore a description is omitted here.

The character data 333 is composed of the species, sex, occupation, height, weight, hairstyle, eye shape, ear shape, life power, fighting power, and money of the character at the time that game was stopped. The character data is as described earlier, and therefore a description thereof is omitted here.

(2) Control Unit 302

Before performing transmission and reception of information with the external apparatus, the control unit 302 controls the authentication unit 304 so as perform mutual device authentication with the external apparatus. When device authentication succeeds, the control unit 302 continues reception and transmission of information with the external apparatus, and when device authentication fails, the control unit 302 stops transmission and reception with the external apparatus.

The control unit 302 receives information via the input/output unit 303, and writes the received information to the information storage unit 301. Furthermore, the control unit 302 reads information from the information storage unit 301, and outputs the read information to the external apparatus via the input/output unit 303.

Specifically, the control unit 302 receives save data, network setting data, the home basic program, and the encryption key from the home game machine 100, and writes the received save data, network setting data, home basic program, and encryption key to the information storage unit 301.

Furthermore, the control unit 302 receives save data and the serial ID from the home game machine 100, receives the portable basic program and the encryption key from the server apparatus 600 via the portable game machine 200, and writes the received save data, network setting data, home basic program and encryption key to the information storage unit 301.

Furthermore, the control unit 302 receives an output request for network setting data, save data, the portable basic program, and the encryption key, from the main control unit 208 of the portable game machine 200. On receiving the output request, the control unit 302 reads the network setting data 312, the save data 330, the portable basic program 311, and the encryption key 313 from the information storage unit 301, and outputs the read network setting data, save data, portable basic program, and encryption key to the portable-game machine 200 via the input/output unit 303.

(3) Input/Output Unit 303

Under the control of the control unit 302, the input/output unit 303 reads information from the information storage unit 301 and outputs the read information to the external apparatus, and also receives information from the external apparatus, and writes the received information to the information storage unit 301.

(4) Authentication Unit 304

Before information is transmitted and received between the control unit 302 and the external apparatus in which the memory card 300 is mounted, the authentication unit 304 performs challenge-response mutual device authentication with the external apparatus under the control of the control unit 302.

Note that since challenge-response authentication is commonly known, a description thereof is omitted here.

The authentication unit 304 outputs a device authentication result to the control unit 302. When device authentication fails, the control unit 302 is prohibited from performing communication and transmission/reception of information with the external apparatus. When device authentication succeeds, the main control unit 302 is permitted to perform communication and transmission/reception of information with the external apparatus.

1.6 Portable Game Machine 200

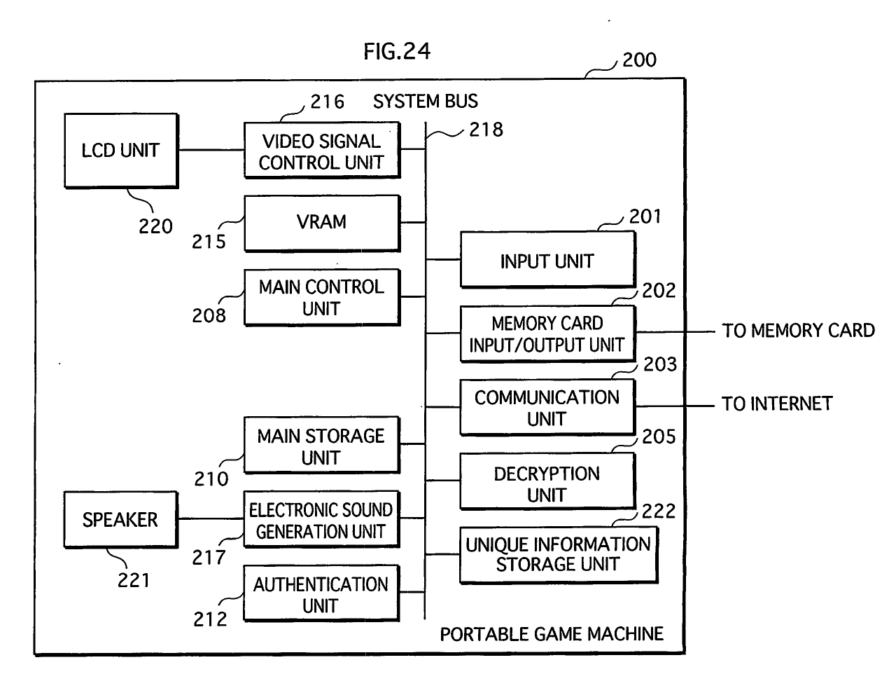

The portable game machine 200, as shown in FIG. 24, is composed of an input unit 201, a memory card input/output unit 202, a communication unit 203, a decryption unit 205, a main control unit 208, a main storage unit 210, an authentication unit 212, a VRAM 215, a video signal generation unit 216, an electronic sound generation unit 217, a system bus 218, an LCD unit 220, speaker 221, and a unique information storage unit 222.

The input unit 201, the memory card input/output unit 202, the communication unit 203, the decryption unit 205, the main control unit 208, the main storage unit 210, the authentication unit 212, the VRAM 215, the audio signal generation unit 216, the electronic sound generation unit 217, and the unique information storage unit 222 are connected to the system bus 218.

The portable game machine 200 is connected to the home game machine 100 over the Internet 200. Furthermore, the memory card 300 is mounted in the portable game machine 200.

(1) Input Unit 201

The input/output unit 201 has buttons including an up button, a down button, a left button, a right button, an OK button, a start button, and a stop button. On receiving an operation of one of the buttons from the user, the input unit 201 generates operation instruction information corresponding to the button of which the operation was received, and outputs the generated operation instruction information to the main control unit 208 via the system bus 118.

(2) Memory Card Input/Output Unit 202 and Communication Unit 203

By being mounted in the portable game machine 200, the memory card input/output unit 202 is connected to the memory card 300. Under the control of the main control unit 208, the memory card input/output unit 202 reads information from the memory card 300, and outputs the read information to the main control unit 208 via the system bus. Furthermore, the memory card input/output unit 202 receives information from the main control unit 208 via the system bus 218, and writes the received information to the memory card 300.

The communication unit 203 is connected to the Internet 20, and performs transmission and reception of information between external apparatuses and the main communication unit 208. Here, the external apparatuses are, specifically, the home game machine 100 and the server apparatus 600.

Furthermore, the communication unit 203 receives network setting data from the main control unit 208, and stores the network setting data as the destination for communication with the home game machine 100.

(3) LCD Unit 220 and Speaker 221

The LCD display unit 220 receives a video signal that includes a vertical retrace period and horizontal retrace periods from the video signal generation unit 216, and displays video based on the received image signal.

The speaker 221 receives an audio signal from the electronic sound generation unit 217, converts the received audio signal to audio, and outputs the audio.

(4) Main Storage Unit 210

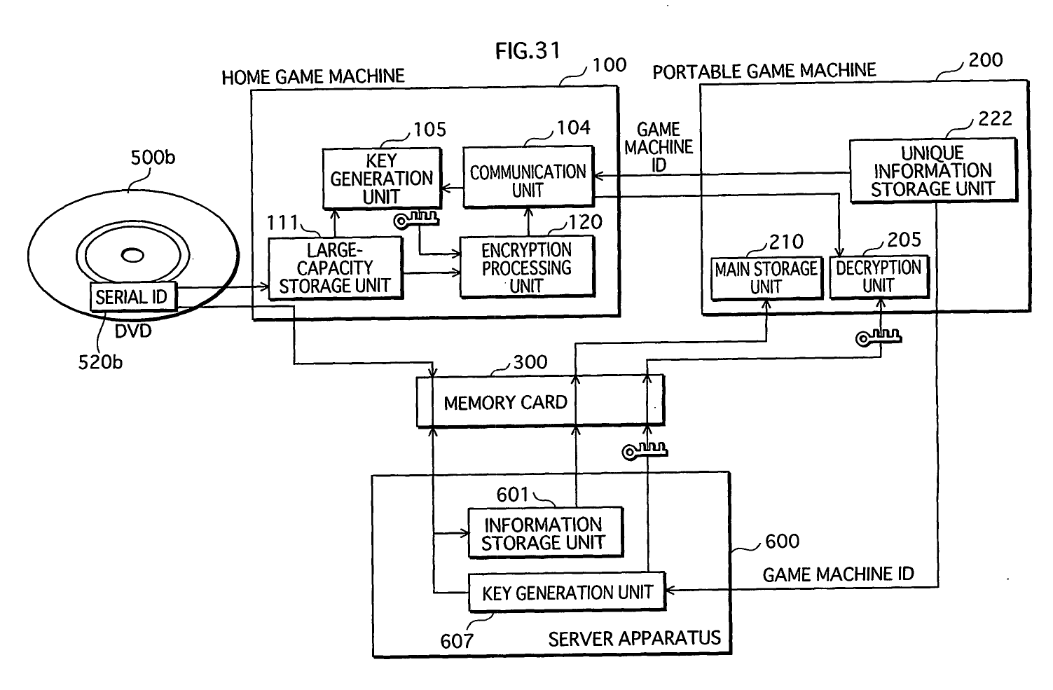

The main storage unit 210 is a RAM, and as one example shown in FIG. 31, stores information such as a portable basic program 231, character data 237, a resume stage No. 238, a resume step No. 239, network setting data 242.

Furthermore, the main storage unit 210 has a frame buffer. The frame buffer has an area for storing one frame image. The frame image is a matrix of 64,000 pixels with 320 pixels in the vertical direction and 200 pixels in the horizontal direction.

(5) Unique Information Storage Unit 222

The unique information storage unit 222 is a ROM, and stores, in advance, a game machine ID unique to the portable game machine 200.

(6) Authentication Unit 212

Before the main control unit 208 performs transmission and reception of information with the external apparatuses connected to the portable game machine 200, the authentication unit 212 performs challenge-response mutual device authentication with the external apparatus, under the control of the main control unit 208.

Note that since challenge-response authentication is commonly known, a description thereof is omitted here.

The authentication unit 212 outputs a device authentication result to the main control unit 208. When device authentication fails, the main control unit 208 is prohibited from performing communication and transmission/reception of information with the external apparatuses. When device authentication succeeds, the main control unit 208 is permitted to perform communication and transmission/reception of information with the external apparatuses.

Here, the external apparatuses are the home game machine 100 and the memory card 300.

(7) Main Control Unit 208

Specifically, the main control unit 208 is composed of a microprocessor and a RAM (not illustrated). Computer programs are stored in the RAM, and the main control unit 208 achieves its functions by the microprocessor operation according to the computer programs.

<Device Authentication>

On receiving input instruction information corresponding to input of the start button from the input unit 201, the main control unit 208 controls the authentication unit 212 so as to perform authentication with the memory card 300. If authentication succeeds, the main control unit 208 performs game processing which is described later. If authentication fails, the main control unit 208 stops subsequent game processing.

<Game Start>

Next, the main control unit 208 checks the contents of the memory card 300.

On judging that the portable basic program is stored in the memory card 300, the main control unit 208 proceeds to game processing.

On judging that the portable basic program is not stored in the memory card 300, the main control unit 208 obtains the portable basic program and the encryption key from the server apparatus 600 according to the following procedure.

The main control unit 208 reads the serial ID 320 from the memory card 300, reads the game machine ID from the unique information storage unit 222, transmits the read serial ID 320 and game machine ID to the server apparatus 600 over the Internet 20, and requests the server apparatus 600 to transmit the portable basic program and the encryption key. On receiving the portable basic program and the encryption key, the main control unit 208 writes the received portable basic program and encryption key to the memory card 300 via the input/output unit 202.

<Game Processing>

Next, the main control unit 208 reads the portable basic program 311 from the memory card 300, writes the read home basic program to the main storage unit 210, reads the save data 330 from the memory card 300, and writes the read save data 330 to the main storage unit 210.

Next, the main control unit 208 fetches one instruction at a time from the home basic program stored in the main storage unit 210, decodes the fetched instruction, and operates according to the decoded instruction. Thereinafter, the main control unit 208 repeatedly fetches, decodes, and executes instructions.

Furthermore, the main control unit 208 performs the following processing in accordance with the progression of the game, to obtain portable character object data, portable attack object data, and portable background object data.

<Obtaining of Portable Object Data>

The main control unit 208 requests encrypted portable object data from the home game machine 100 in accordance with the progression of the game.

When the type of DVD being used by the home game machine 100 to execute the game is the DVD 500b, an encryption key is not stored in the home game machine 100. Since it is necessary for the home game machine 100 to generate an encryption key for encrypting transmission data in such a case, the main control unit 208 receives a game machine ID transmission request from the home game machine 100. On receiving the game machine ID transmission request, the main control unit 208 reads the game machine ID from the unique information storage unit 222, and transmits the read game machine ID to the home game machine 100 over the Internet 20.

When the type of DVD being used by the home game machine 100 to execute the game is the DVD 500a, the main control unit 208 proceeds to the next processing without a game ID transmission request from the home game machine 100.

Next, the main control unit 208 receives encrypted portable object data over the Internet 20 and the communication unit 203. On receiving the encrypted portable object data, the main control unit 208 outputs the received encrypted portable object data to the decryption unit 205.

Next, the main control unit 208 reads the encryption key 244 from the main storage unit 210, outputs the read encryption key to the decryption unit 205, and requests the decryption unit 205 to decrypt the encrypted portable object data. Next, the main control unit 208 receives the portable object data from the decryption unit 205, and writes the received portable object data to the main storage unit 210.

(8) Decryption Unit 205

On receiving a decryption request from the main control unit 208, the decryption unit 205 receives the encrypted object data and the encryption key. The decryption unit 205 applies a decryption algorithm D1 to the encrypted portable object data with use of the received encryption key, thereby generating portable object data.

Here, the decryption algorithm D1 is an algorithm for decrypting cipher text generated according to the encryption algorithm E1.

(9) VRAM 215

The VRAM 215 has an area for storing one frame image. The frame image is a matrix of 64,000 pixels with 320 pixels in the vertical direction and 200 pixels in the horizontal direction. Here, the frame image is the same size as that stored by the frame buffer.

(10) Video Signal Generation Unit 216

The video signal generation unit 216 performs the following processing (a) and (b) every 1/60th of a second.

(a) The video signal generation unit 216 generates a vertical synchronization signal, and outputs the vertical synchronization signal to the LCD unit 220. This period is called a vertical retrace period.

(b) The video signal generation unit 216 performs the following (b1) to (b3) 200 times, in other words, a number of times equal to the number of horizontal pixels in the frame image.

(b1) The video signal generation unit 116 reads one horizontal line of pixels (320 pixels) of the frame image in the VRAM 215.

(b2) The video signal generation unit 216 generates an image signal of one line of the read frame image, and generates a horizontal synchronization signal.

(b3) The video signal generation unit 216 outputs the generated image signal and horizontal synchronization signal to the LCD unit 220.

(11) Electronic Sound Generation Unit 217

Under the control of the main control unit 208, the electronic sound generation unit 217 reads digital audio information from the main storage unit 210, decodes the read audio information, converts the decoded audio information to an analog audio signal, and outputs the analog audio signal to the speaker 221.

1.7 Structure of the Server Apparatus 600

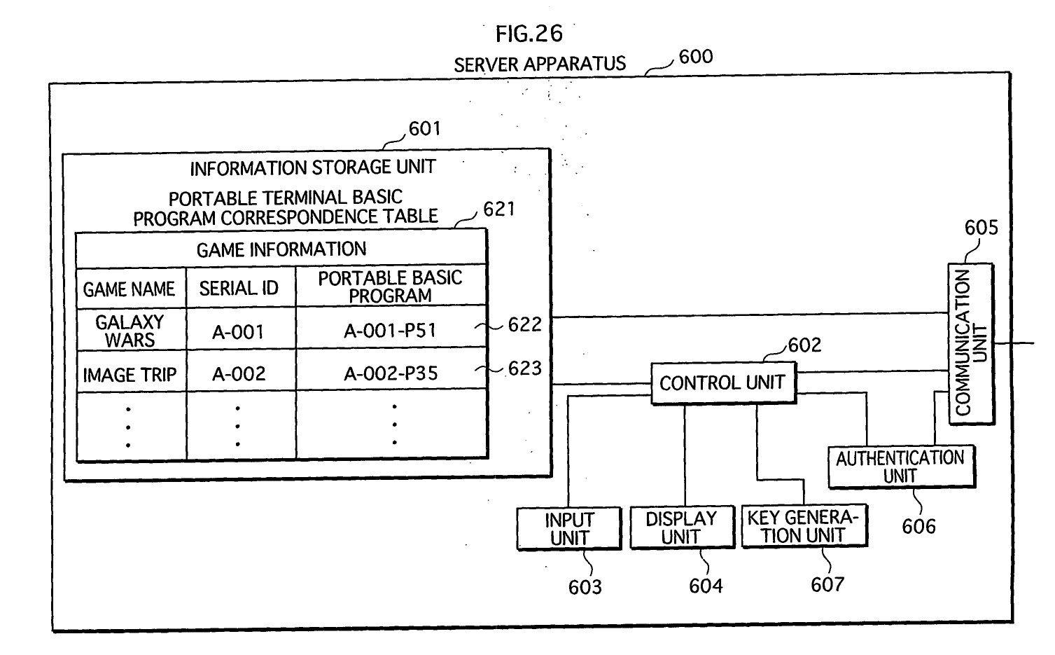

The server apparatus 600, as shown in FIG. 26, is composed of an information storage unit 601, a control unit 602, an input unit 603, a display unit 604, an authentication unit 606, and a key generation unit 607.

Specifically, the server apparatus 600 is a computer system that includes a microprocessor, a ROM, a RAM, a hard disk unit a keyboard, and a mouse. Computer programs are stored in the RAM or the hard disk unit, and the server apparatus 600 achieves its functions by the microprocessor operating according to the computer programs.

(1) Information Storage Unit 601

The information storage unit 601, as shown in FIG. 26, has a portable terminal basic program correspondence table 621.

<Portable Terminal Basic Program Correspondence Table 621>

The portable terminal basic program correspondence table 621, as shown in FIG. 26, is composed of a plurality of pieces of game information. Each piece of game information is composed of a game name, a serial ID, and a portable basic program.

The serial ID is identification information for identifying game software. The serial IDs correspond respectively to the portable basic programs.

(2) Authentication Unit 606

Before the control unit 602 performs communication with the external apparatus via the communication unit 605, the authentication unit 606 performs challenge-response mutual authentication with the external apparatus, under the control of the control unit 602.

Note that since the challenge-response method is commonly known, a description thereof is omitted.

The authentication unit 606 outputs a device authentication result to the control unit 602. When device authentication has fails, the control unit 602 is prohibited from performing communication and transmission/reception of information with the external apparatus. When device authentication succeeds, the control unit 602 is permitted to perform communication and transmission/reception of information with the external apparatus.

Here, the external apparatus is the portable game machine 200.

(3) Communication Unit 605

The communication unit 605 is connected to the portable game machine 200 over the Internet 20.

The communication unit 605 performs transmission and reception of information over the Internet 20 between the portable game machine 200 and the authentication unit 606, and between the portable game machine 200 and the control unit 602.

(4) Control Unit 602

On receiving a request for the encryption key and the portable basic program, as well as the serial ID and the game machine ID, from the portable game machine 200 over the Internet 20 and the communication unit 605, the control unit 602 controls the authentication unit 606 so as to perform device authentication with the portable game machine 200. If authentication succeeds, the control unit performs transmission processing of the encryption key and the portable basic program, as described in the following. If authentication fails, the control unit 602 ceases subsequent processing.

The control unit 602 compares the serial ID received from the portable game machine 200 with the serial IDs in the portable terminal basic program correspondence table 621, and reads the requested portable basic program.

Next, the control unit 602 outputs the serial ID and the game machine ID received from the portable game machine 200 to the key generation unit 607, and controls the key generation unit 607 so as to generate an encryption key. The control unit 602 then receives the encrypted key from the key generation unit 607.

Next, the control unit transmits the read portable basic program and the encryption key received from the key generation unit 607 to the portable game machine 200 via the communication unit 605 and the Internet 20.

(5) Key Generation Unit 607

The key generation unit 607 stores, in advance, a system secret value which is the same as the system secret value stored in the key generation unit 105 of the home game machine 100.

The key generation unit 607 receives a key generation request, the serial ID, and the game machine ID from the control unit 602.

The key generation unit 607 then concatenates the serial ID and the game machine ID, to generate 24-bit ID data, and subjects the generated ID data to DES encryption processing with use of the system secret value.

Next, the key generation unit 607 outputs the encrypted ID data to the main control unit 208 as the encryption key.

Note that the method used by the key generation unit 607 to generate the encryption key is the same as that used by the key generation unit 105 of the home game machine 100.

(7) Input Unit 603 and Display Unit 604

The input unit 603 receives input of data or an instruction from the operator of the server apparatus 600, and outputs the received data or instruction to the control unit 602.

The display unit 604 displays various types of information under the control of the control unit 602.

1.8 Base Station 30

The base station 30 is for relaying communication between the Internet 20 and the portable game machine 200.

1.9 Operations of the Game System 10

The following describes operations of the game system 10.

(1) Operations of the Home Game Machine 100

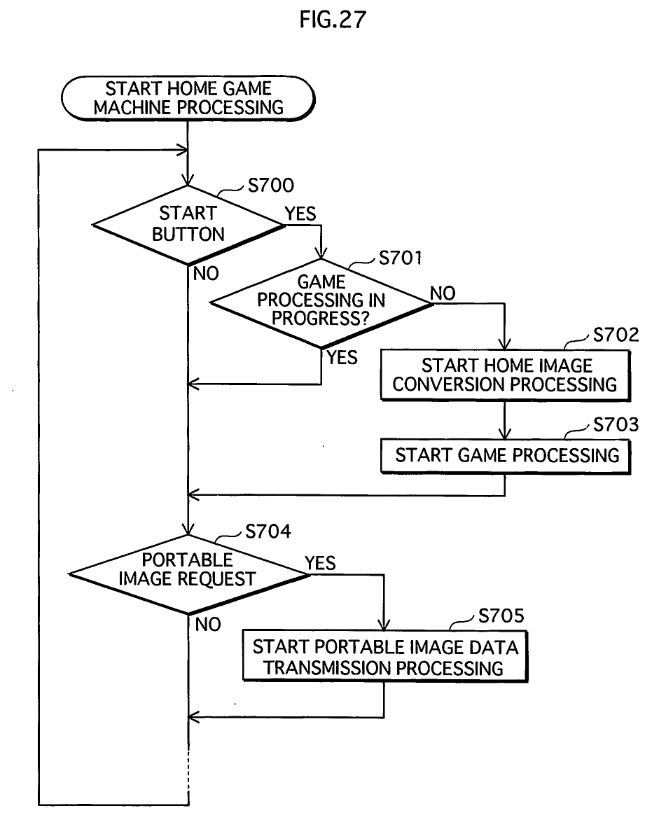

The following describes operations of the home game machine 100 with use of the flowchart shown in FIG. 27.

When the power of the home game machine 100 is on, the home game machine 100 judges whether or not operation instruction information corresponding to a press of the start button is received (step S700), and when it is judged that such operation instruction information is not received (step S700), proceeds to the processing at step S704.

When it is judged that operation instruction information corresponding to a press of the start button is received (step S700), the home game machine 100 judges whether or not a game is currently being executed (step S701). When it is judged that a game is being executed (step S701), the home game machine 100 moves the processing to step S704.

When it is judged that a game is not currently being executed (step S701), the home game machine 100 reads the general image data from the DVD 500a or the DVD 500b, and commences processing to convert the read general image data to home apparatus image data (step S702).

Next, the home game machine 100 reads the home basic program from the DVD 500a or the DVD 500b, and commences game processing (step S703).

On receiving an image request from the portable game machine 200 (step S704), the home game machine 100 commences portable image data transmission processing (step S705).

Thereinafter, the home game machine 100 repeats home image conversion processing, game processing, and portable image data transmission processing upon receiving operation instruction information corresponding to a press of the start button or upon receiving a portable image request.

(2) Home Image Data Generation Processing by the Home Game Machine 100

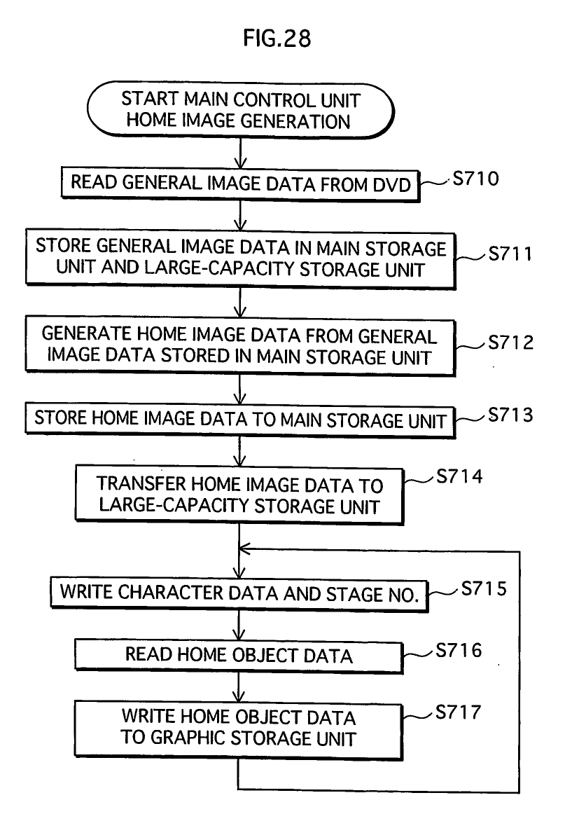

The following describes home image data generation processing by the home game machine 100 with use of the flowchart shown in FIG. 28. Note that the operations described here are details of step S702 in the flowchart shown in FIG. 27.

The main control unit 108 reads the general image data 503a or 503b from the DVD 500a or 500b (step S710), and writes the read general image data 503a or 503b to the main storage unit 110 and the large-capacity storage unit 111 (step S711).

Next, the main control unit 108 generates home image data from the general image data stored in the main storage unit 110 (step S712). Specifically, the main control unit 108 calculates the coordinate points of the surface of the general image data that is 3-D surfaces and 3-D curves, and converts the calculated coordinate points to 3-D polygon data approximating a 3-D polyhedron. When calculating the coordinate points of the surface, the quality of the generated image becomes more precise if the number of control points is increased, and rougher if the number of control points is reduced. The main control unit 108 generates 3D polygon data of an image quality suitable for the display ability of the home game machine 100.

Note that details of the conversion method are disclosed in Patent Document 4 and Patent Document 5, and therefore a description thereof is omitted here.

Next, the main control unit 108 writes the home image data to the main storage unit 110 (step S713), and writes the home image data to the large-capacity storage unit 111 (step S714).

The main control unit 108 commences the game in accordance with the procedure shown by the home basic program, and when character data is written to the main storage unit 110 (step S715), reads the home character object data and the home attack object data (step S716), and writes the read home character object data and home attack object data to the graphic storage unit 114.

Furthermore, upon the resume game step in the main storage unit 110 being overwritten in accordance with the progression of the game (step S716), the main control unit 108 reads the home background object data corresponding to the new game step from the main storage unit 110 (step S716), and writes the read home background object data to the graphic storage unit 114 (step S717).

(3) Game Processing by the Home Game Machine 100

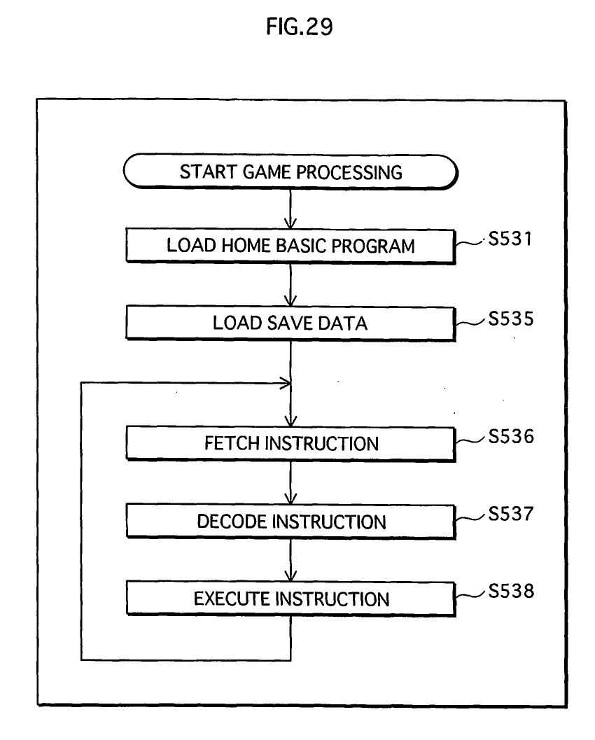

The following describes operations by the home game machine 100 for game processing, with use of the flowchart shown in FIG. 29. Note that the operations described here are details of step S703 in the flowchart shown in FIG. 27.

The main control unit 108 reads the home basic program 501a or 501b from the DVD 500a or 500b, and writes the read home basic program 501a or 501b to the main storage unit 110 (step S531).

Next, the main control unit 108 reads the save data 330 from the memory card 300, writes the read save data to the main storage unit 110, and, from among the character data included in the read save data, writes the height and weight to the graphic storage unit 114 (step S535).

Next, the main control unit 108 fetches one instruction at a time from the home basic program stored in the main storage unit 110 (step S536), decodes the fetched instruction (step S537), and operates according to the decoded instruction (step S538). Thereinafter, the main control unit 108 repeatedly fetches, decodes, and executes instructions.

(4) Portable Image Data Transmission Processing by the Home Game Machine 100

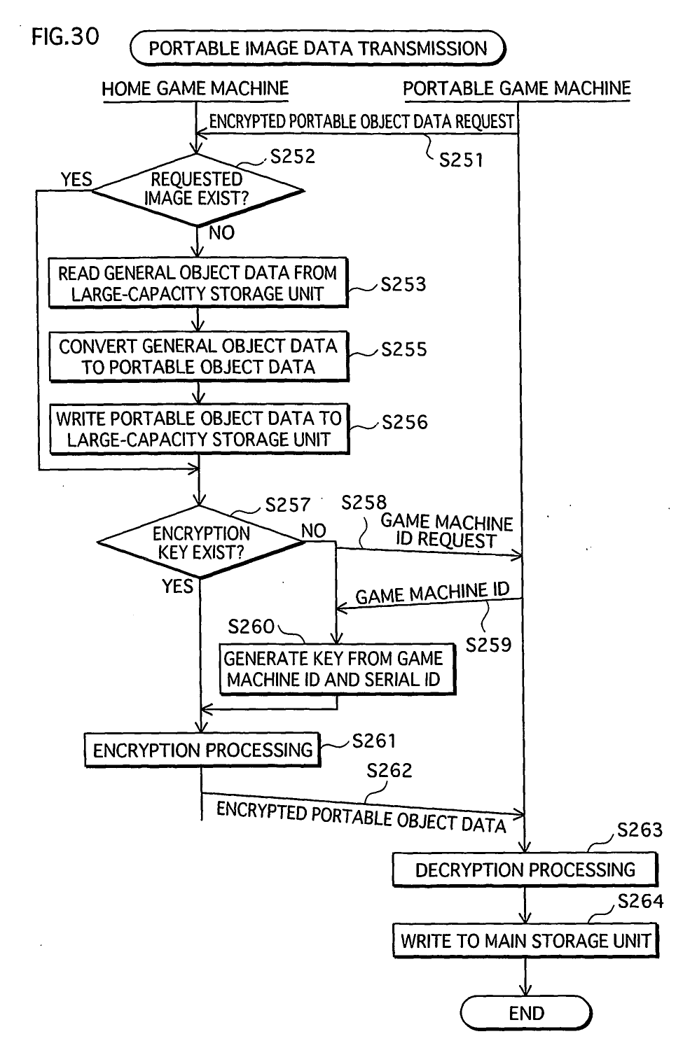

The following describes the operations by the home game machine 100 for transmitting portable image data, with use of the flowchart shown in FIG. 30. Note that the operations described here are details of step S705 in the flowchart shown in FIG. 27.

On receiving a request for encrypted portable character data, encrypted portable attack object data, or encrypted portable background object data corresponding to stage No. i (i being an integer from 1 to n), from the portable game machine 200 over the Internet 20 (stepS251), the main control unit 108 checks whether or not portable object data corresponding to the requested image data already exists in the large-capacity storage unit 111 (step S252). When such portable object data is judged to exist (step S252), the main control unit 108 moves to the processing at step S257.

When such portable object data is judged not to exist in the large-capacity storage unit 111 (step S252), the main control unit 108 reads the general object data corresponding to the requested image data (step S253), generates portable object data from the read general object data (step S255), and writes the generated portable object data to the large-capacity storage unit 111 (step S256).

Next, the main control unit 108 checks whether an encryption key is stored in the large-capacity storage unit 111 (step S257), and when an encryption key is judged to be stored in the large-capacity storage unit 111 (step S257), moves the processing to step S261.

When an encryption key is judged not to be stored in the large-capacity storage unit 111 (step S257), the main control unit 108 requests the game machine ID from the portable game machine 200 over the Internet 20 (step S258). On receiving the game machine ID request from the home game machine 100, the main control unit 208 reads the game machine ID from the unique information storage unit 222, and transmits the read game machine ID over the Internet 20 (step S259).

On receiving the main game machine ID, the main control unit 108 reads the serial ID from the large-capacity storage unit 111, outputs the received game machine ID and the read serial ID to the key generation unit 105, and requests encryption key generation. The main control unit 108 then receives the encryption key from the key generation unit 105, and writes the encryption key to the large-capacity storage unit 111 (step S260).

Next, the main control unit 108 reads the encryption key and the portable object data corresponding to the image data requested by the portable game machine 200 from the large-capacity storage unit 111, outputs the read encryption key and portable object data to the encryption processing unit 112, and requests the encryption processing unit 112 to perform encryption processing of the output portable object data (step S261). The encryption processing unit 112 applies the encryption algorithm E1 to the portable object data with use of the encryption key, thereby generating encrypted portable object data, and outputs the generated encrypted portable object data to the main control unit 108 (step S261). The main control unit 108 transmits the received encrypted portable object data to the portable game machine 200 over the Internet 20 (step S262).

Note that generation of portable image data is, specifically, processing for converting the general image data, which is 3-D surfaces and 3-D curves, to 3-D polygon data approximating a 3-D polyhedron. The conversion method is the same as the processing described above for the home image data, with the exception that the number of control points is reduced when calculating the coordinate points, to generate rough 3-D polygon data suitable for the display ability of the portable game machine 200. Details of this conversion method are disclosed in Patent Document 4 and Patent Document 5, and therefore a description thereof is omitted here.

On receiving the encrypted portable object data (step S262), the main control unit 208 outputs the received encrypted portable object data to the decryption unit 205. Next, the main control unit 208 reads the encryption key 244 from the main storage unit 210, outputs the read encryption key 244 to the decryption unit 205, and requests the decryption unit 205 to perform decryption processing of the encrypted portable object data. The decryption unit 205 applies the decryption algorithm D1 to the encrypted portable object data with use of the encryption key, thereby generating portable object data (step S263), and writes the generated portable object data to the main storage unit 210 (step S264).

Here, the decryption algorithm D1 is an algorithm for decrypting cipher text generated according to the encryption algorithm E1. As one example, the encryption algorithm E1 conforms to DES.

(5) Operations of the Portable Game Machine 200

The following describes operations by the portable game machine 200, with use of the flowchart shown in FIG. 32. The flow of information in these operations is shown by the block diagram in FIG. 31.

On receiving operation information corresponding to a press of the start button, the main control unit 208 checks whether the portable basic program is stored in the memory card 300 (step S801), and when the portable basic program is judged to be stored in the memory card 300 (step S801), moves to the processing at step S822.

When the portable basic program is judged not to be stored in the memory card 300 (step S802), the main control unit 208 reads the serial ID 320 from the memory card 300 (step S803), and reads the game machine ID from the unique information storage unit 222 (step S804). The main control unit 208 transmits the read serial ID and game machine ID to the server apparatus 600 over the Internet 20, and requests the portable basic program and the encryption key (step S811).

On receiving the serial ID, the game ID and the request for the portable basic program and encryption key from the portable game machine 200 over the Internet 20 (step S811), the control unit 602 outputs the received serial ID and game machine ID to the key generation unit 607, and requests the key generation unit 607 to generate an encryption key. The key generation unit 607 generates 24-bit ID data from the serial ID and the game machine ID, and generates an encryption key based on the generated ID data and a system secret value stored in advance. The key generation unit 607 outputs the generated encryption key to the control unit 602 (step S812).

Next, the control unit 602 selects, from the portable terminal basic program correspondence table 621 in the information storage unit 601, game information corresponding to the received serial ID, and reads the portable basic program indicated in the selected game information (step S813).

The control unit 602 transmits the read portable basic program and the encryption key to the portable game machine 200 over the Internet 20 (step S814).

On receiving the portable basic program and the encryption key from the server apparatus 600 (step S814), the main control unit 208 writes the received portable basic program to the memory card 300 via the memory card input/output unit 202 (step S821).

Next, the main control unit 208 reads the portable basic program 311 from the memory card 300, and writes the read portable basic program to the main storage unit 210 (step S822).

The main control unit 208 then reads the save data 330 from the memory card 300, and writes the read save data to the main storage unit 210 (step S823).

Next, the main control unit 208 fetches one instruction at a time from the portable basic program 231 stored in the main storage unit 210 (step S823), decodes the fetched instruction (step S824), and operates according to the decoded instruction (step S825). Thereinafter, the main control unit 208 repeatedly fetches, decodes, and executes instructions.

### 2. CONCLUSION

As has been described, according to the present invention, image data that, according to conversion processing, is able to be displayed by either a home game machine or a portable game machine, and a game program that is executable by the home game machine, are provided to the user, recorded on a recording medium that is readable by the home game machine. A game program that is executable by the portable game machine with a game of the same contents as the game program executable by the home game machine is provided to the user on the recording medium, or over the Internet from a server apparatus.

The game program that is executable by the portable game machine is recorded from the recording medium to the memory card via the home game machine or from the server apparatus via the portable game machine.

Furthermore, character data indicating characteristics such as appearance and ability of characters that appear in the game is stored on the memory card, as well as the state of progression of the game when the game is stopped.

The home game machine reads the game program and the image data from the storage medium, reads the character data and the state of progression of the game at the point of being stopped, from the memory card, converts the image data to image data of a quality suitable for the home game machine, and proceeds with the game in accordance with the game program.

The portable game machine reads the game program and the state of progression of the game from the memory card, obtains, over the Internet, portable image data that has been converted by the home game machine so as to be of an suitable quality for the portable game, and proceeds with the game in accordance with the game program.

At this time, the home game machine and the portable game machine are able to make characters appear in the game that have the appearance and ability indicated by the character data read from the memory card, and resume the game from the state indicated by the state of progress when the game was stopped.

In this way, home game software can be enjoyed in a portable game machine that has lower processing ability, regardless of specifications of the game machines such as the system architecture, type and number of processors, and the screen display ability. Furthermore, images are displayed on the screen with a quality suitable for the display ability of the particular game machine.

Note that the portable game machine 200 described in the embodiment is not limited to the being a special-purpose game machine, but may be any type of portable terminal that has a memory card slot and a game function, examples being a mobile telephone and a PDA (personal digital assistant).

3. Modifications

Although the present invention has been described based on the preferred embodiment, the present invention is not limited to the preferred embodiment. Cases such as the following are included in the present invention.

(1) As one variation of the game system 10, the general image data 503a and 503b recorded on the DVD 500a and the DVD 500b may be 3D polygon data instead of being 3D curved surface and curved line data.

(2) The general image data 503a and 503b recorded on the DVD 500a and the DVD 500b may be home image data.

When the game is executed using the home game machine, a display screen is generated using the general image data without conversion, and when transmitting images to the portable game machine 200, the general image data is converted to rough polygon data before being transmitted, as described in the embodiment.

(3) In the described embodiment, the general image data is converted to home image data or portable image data for use. However, if the capacity of the DVD 500a or the DVD 500b allows, both home image data and portable image data may be stored in advance on the DVD 500a or the DVD 500b.

(4) When the DVD 500b is used in the described embodiment, the serial ID 520b is the information unique to the game software. However, information unique to the DVD itself may be used instead.

If the DVD unique serial ID is transmitted when receiving the mobile basic program from the server apparatus 600, the server apparatus 600 is able to record how many times the basic program has been transmitted with respect to the serial ID.

If a limit for the number of times that the basic program can be transmitted with respect to the one serial ID is provided, the server apparatus 600 rejects further program transmission requests once the number is reached. Restricting the number of times the basic program is transmitted prevents the mobile basic program from being distributed to a user other than the purchaser of the game software.

(5) The mobile basic program may be sold for a cost in cases in which the DVD 500b is used in the described embodiment. When transmitting the portable basic program, the server apparatus performs billing processing to bill the user specified by the game machine ID sent from the portable game machine.

(6) An alternative structure to the billing processing described in (5), is one in which the memory card 300 has an electronic money function, and performs payment processing. Specifically, the memory card 300 receives payment request information, and performs the payment processing based on the received payment request information.

The memory card 300 stores a secret key, and so-called electronic money that can be used in place of currency, in an area that is not accessible from outside. The memory card 300 also stores in advance a billing origin ID that identifies the server apparatus 600.

Furthermore, the server apparatus 600 stores in advance a public key that corresponds to the secret key of the memory card 300, and a billing origin ID that identifies the server apparatus 600 itself.

The server apparatus 600 calculates the billing amount, obtains the billing origin ID that identifies the server apparatus 600, applies a digital signature SIG to the billing amount and the billing origin ID, with use of the public key of the memory card 300 obtained in advance, thereby generating signature data, and transmits the billing amount, the billing origin ID, and the signature data to the memory card 300 via the Internet 200 and the home game machine 100.

The memory card 300 applies digital signature verification VRFY to the received billing amount, billing origin ID and signature data, with use of the secret key that is stored in advance in the memory card 300. If verification results in failure, the memory card 300 transmits failure information indicating the verification failure, to the server apparatus 300, via the home game machine 100 and the Internet 20.

If verification results in success, the memory card 300 further judges whether the pre-stored billing origin ID and the received billing origin ID match, and when the two do not match, transmits failure information indicating that the two do not match, to the server apparatus 600 via the portable game apparatus 100 and the Internet 20.

When the two billing origin IDs match, the memory card 300 subtracts the received billing amount from the internally stored electronic money.

(7) In the preferred embodiment, the portable game machine 200 receives the portable basic program from the distribution server apparatus 600 while the memory card 300 is mounted in the portable game machine 200, when the DVD mounted in the home game machine 100 is the DVD 500b. However, the home game machine 100 may receive the potable basic program while the memory card 300 is mounted in the home game machine 100, and write the received portable basic program to the memory card 300.

The memory card 300 is then mounted in the portable game machine 200, and the game is executed following the portable basic program that the home game machine 100 wrote to the memory card 300.

(8) The present invention is a distribution server apparatus that distributes a game program, including: a storage unit operable to store the game program, the game program showing a procedure of a game; a reception unit operable to receive a game program transmission request from a home game execution apparatus or a portable game execution apparatus; a read unit operable to read the game program from the storage unit; and a transmission unit operable to transmit the read game program over a network to the home game execution apparatus or the portable game execution apparatus.

Here, the home game execution apparatus may generate a distribution key, read general image data that is displayed in accordance with progress of the game, from a game recording medium, generate, from the read general image data, a portable image that is suitable for display by the portable game execution apparatus, encrypt the generated portable image with use of the generated distribution key, thereby generating portable image data, and transmit the generated portable image data over the network. The distribution server apparatus may further include a generation unit operable to generate a distribution key that is identical to the distribution key generated in the home game execution apparatus, wherein the reception unit further receives a distribution key request from the portable game execution apparatus, transmits the distribution key generated by the generation unit to the portable game execution apparatus over the network, and the portable game execution apparatus receives the portable image data from the home execution apparatus over the network, and receives the distribution key from the distribution server, and decrypts the portable image data with use of the distribution key, to generate a portable image.

(9) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM (compact disc-read only memory), and MO (magneto-optical), a DVD-ROM (digital versatile disc-read only memory), a DVD-RAM (digital versatile disc-random access memory, a BD (Blu-Ray Disc) or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal over a network or the like, the program or the digital signal may be executed by another independent computer system.

(10) The present invention may be any combination of the above-described embodiments and modifications.

### INDUSTRIAL APPLICABILITY

The described sales system can be used advantageously for business purposes, and repeatedly and continuously, by a retailer in an industry that provides computer game software to users, and an industry that produces and sells home game machined, portable game machines and computer systems for executing computer game software.

1. A game system comprising a stationary game execution apparatus, a mobile game execution apparatus and a monitor, each of the game execution apparatuses executing a game in accordance with a game program,
the stationary game execution apparatus including:
an obtaining unit operable to obtain the game program and general image data, the game program indicating a game procedure, and the general image data being for display in accordance with progression of the game;
a write unit operable to write the obtained game program to a portable recording medium;
a generation unit operable to generate stationary image data and portable image data from the obtained general data, the stationary image data being suitable for display by the stationary game execution apparatus, and the portable image data being suitable for display by the portable game apparatus;
a transmission unit operable to transmit the generated portable image data over a network;
an input unit operable to receive an input operation from a user; and
an execution unit operable to execute, based on the received input operation, the game, in accordance with the procedure indicated by the obtained game program, and generate, in accordance with progression of the game, a stationary display image from the generated stationary image data, and output the generated stationary display image,
the monitor displaying the output stationary display image, and
the portable game apparatus including:
a read unit operable to read the game program from the portable recording medium;
a reception unit operable to receive the portable image data over the network;
an input unit operable to receive an input operation from the user;
an execution unit operable to execute, based on the received input operation, the game, in accordance with the procedure indicated by the read game program, and generate, in accordance with progression of the game, a portable display image from the received portable image data; and
a display unit operable to display the generated portable display image.

2. The game system of claim 1, further comprising a distribution server, the distribution server, including:
a storage unit operable to store the game program;
a read unit operable to read the game program from the storage unit; and
a transmission unit operable to transmit the read game program securely over the network, and
the mobile game execution apparatus further including:
a reception unit operable to receive the game program over the network; and
a write unit operable to write the received game program to the portable recording medium,
wherein, instead of the stationary game execution apparatus writing the game program to the portable recording medium, the mobile game execution apparatus writes the received game program to the portable recording medium.

3. A stationary game execution apparatus that executes a game in accordance with a game program, comprising:
an obtaining unit operable to obtain the game program and general image data, the game program indicating a game procedure, and the general image data being for display in accordance with progression of the game;
a write unit operable to write the obtained game program to a portable recording medium;
a generation unit operable to generate stationary image data and portable image data from the obtained general data, the stationary image data being suitable for display by the stationary game execution apparatus, and the portable image data being suitable for display by the portable game apparatus;
a transmission unit operable to transmit the generated portable image data over a network;
an input unit operable to receive an input operation from a user; and
an execution unit operable to execute, based on the received input operation, the game, in accordance with the procedure indicated by the obtained game program, and generate, in accordance with progression of the game, a stationary display image from the generated stationary image data, and output the generated stationary display image to a monitor.

4. The stationary game execution apparatus of claim 3, wherein
the game program and the general image data are stored on a recording medium, and
the obtaining unit obtains the game program and the general image data by reading the game program and the general image data from the recording medium.

5. The stationary game execution apparatus of claim 3, wherein
a distribution server apparatus stores therein the game program and the general image data, and reads the game program and transmits the read game program over the network, and
the obtaining unit obtains the game program and the general image data by receiving the game program and the image data from the distribution server apparatus over the network.

6. The stationary game execution apparatus of claim 3, wherein
the generation unit transmits the portable image data securely over the network.

7. The stationary game execution apparatus of claim 6, wherein
the generation unit generates, from the general image data, a portable image suitable for display by the portable game execution apparatus, and encrypts the generated portable image, thereby generating portable image data.

8. The stationary game execution apparatus of claim 7, wherein
the generation unit generates a distribution key, and uses the generated distribution key in encryption of the portable image, and
the write unit further writes the generated distribution key to the portable recording medium.

9. The stationary game execution apparatus of claim 3, wherein
the input unit further receives a stop instruction indicating stopping of the game at a point part way through,
the execution unit generates state data indicating a state of progression of the game at the point at which the stop operation was received, and
the write unit further writes the generated state information to the portable recording medium.

10. The stationary game execution apparatus of claim 3, further comprising:
a storage unit operable to store address information indicating a connection location of the stationary game execution apparatus on the network,
wherein the write unit further reads the address information, and writes the address information to the portable recording medium.

11. A portable game execution apparatus that executes a game in accordance with a game program,
wherein a stationary game execution apparatus obtains the game program and general image data, the game program indicating a game procedure, and the general image data being for display in accordance with progression of the game, writes the obtained game program to a portable recording medium, generates stationary image data and portable image data from the obtained general data, the stationary image data being suitable for display by the stationary game execution apparatus, and the portable image data being suitable for display by the portable game apparatus, and transmits the generated portable image data over a network,
the portable game execution apparatus comprising:
a read unit operable to read the game program from the portable recording medium;
a reception unit operable to receive the portable image data over the network;
an input unit operable to receive an input operation from the user;
an execution unit operable to execute, based on the received input operation, the game, in accordance with the procedure indicated by the read game program, and generate, in accordance with progression of the game, a portable display image from the received portable image data; and
a display unit operable to display the generated portable display image.

12. The portable game execution apparatus of claim 11, wherein
the reception unit securely receives the portable image data over the network.

13. The portable game execution apparatus of claim 12, wherein
the stationary game execution apparatus generates, from the general image data, a portable image suitable for display by the portable game execution apparatus, and encrypts the generated portable image, thereby generating portable image data, and
the execution unit decrypts the received portable image data, thereby generating a portable image, and generates a portable display image from the generated portable image.

14. The portable game execution apparatus of claim 13, wherein
the portable recording medium further stores a distribution key used in the encryption of the portable image, and
the execution unit further reads the distribution key from the portable recording medium, and decrypts the received portable image data with use of the read distribution key.

15. The portable game execution apparatus of claim 13,
wherein the stationary game execution apparatus generates a distribution key, generates, from the general image data, a portable image suitable for display by the portable game execution apparatus, encrypts the generated portable image with use of the generated distribution key, thereby generating portable image data, and transmits the portable image data over the network,
the distribution server apparatus generates a distribution key that is identical to the distribution key generated by the stationary game execution apparatus, and transmits the generated distribution key over the network,
the reception unit further receives the distribution key from the distribution server apparatus over the network, and writes the received distribution key to the portable recording medium, and
the execution unit further reads the distribution key from the portable recording medium, and decrypts the received portable image data with use of the read distribution key.

16. The portable game execution apparatus of claim 11, wherein
the portable recording medium further stores state data indicating a state of progression of the game at a point at which the game was stopped part way through, and
the execution unit further reads the state data from the portable recording medium, and resumes the game from the point at which the game was stopped, with use of the read state data.

17. The portable game execution apparatus of claim 11, wherein
the portable recording medium further stores address information indicating a connection location of the stationary game execution apparatus on the network, and
the reception unit reads the address information from the portable recording medium, and receives the portable image data from the stationary game execution apparatus shown by the connection location on the network indicated by the read address information.

18. The portable game execution apparatus of claim 11, wherein
the distribution server apparatus stores the game program therein, and reads the game program and transmits the read game program over the network,
instead of the stationary game execution apparatus writing the game program to the portable recording medium, the reception unit further receives the game program over the network, and writes the received game program to the recording medium, and
the read unit reads the game program that has been written to the portable recording medium by the reception unit, from the portable recording medium.

19. A game execution method used in a stationary game execution apparatus that executes a game in accordance with a game program, the game execution method comprising:
an obtaining step of obtaining the game program and general image data, the game program indicating a game procedure, and the general image data being for display in accordance with progression of the game;
a write step of writing the obtained game program to a portable recording medium;
a generation step of generating stationary image data and portable image data from the obtained general data, the stationary image data being suitable for display by the stationary game execution apparatus, and the portable image data being suitable for display by the portable game apparatus;
a transmission step of transmitting the generated portable image data over a network;
an input step of receiving an input operation from a user; and
an execution step of executing, based on the received input operation, the game, in accordance with the procedure indicated by the obtained game program, and generating, in accordance with progression of the game, a stationary display image from the generated stationary image data, and outputting the generated stationary display image to a monitor.

20. A game execution program used in a stationary game execution apparatus that executes a game in accordance with a game program, the game execution program comprising:
an obtaining step of obtaining the game program and general image data, the game program indicating a game procedure, and the general image data being for display in accordance with progression of the game;
a write step of writing the obtained game program to a portable recording medium;
a generation step of generating stationary image data and portable image data from the obtained general data, the stationary image data being suitable for display by the stationary game execution apparatus, and the portable image data being suitable for display by the portable game apparatus;
a transmission step of transmitting the generated portable image data over a network;
an input step of receiving an input operation from a user; and
an execution step of executing, based on the received input operation, the game, in accordance with the procedure indicated by the obtained game program, and generating, in accordance with progression of the game, a stationary display image from the generated stationary image data, and outputting the generated stationary display image to a monitor.

21. The game execution program of claim 20, stored on a computer readable recording medium.

22. A game execution method used in a portable game execution apparatus that executes a game in accordance with a game program,
wherein a stationary game execution apparatus obtains the game program and general image data, the game program indicating a game procedure, and the general image data being for display in accordance with progression of the game, writes the obtained game program to a portable recording medium, generates stationary image data and portable image data from the obtained general data, the stationary image data being suitable for display by the stationary game execution apparatus, and the portable image data being suitable for display by the portable game apparatus, and transmits the generated portable image data over a network,
the game execution method comprising:
a read step of reading the game program from the portable recording medium;
a reception step of receiving the portable image data over the network;
an input step of receiving an input operation from the user;
an execution step of executing, based on the received input operation, the game, in accordance with the procedure indicated by the read game program, and generating, in accordance with progression of the game, a portable display image from the received portable image data; and
a display step of displaying the generated mobile image.

23. A game execution program used in a portable game execution apparatus that executes a game in accordance with a game program,
wherein a stationary game execution apparatus obtains the game program and general image data, the game program indicating a game procedure, and the general image data being for display in accordance with progression of the game, writes the obtained game program to a portable recording medium, generates stationary image data and portable image data from the obtained general data, the stationary image data being suitable for display by the stationary game execution apparatus, and the portable image data being suitable for display by the portable game apparatus, and transmits the generated portable image data over a network,
the game execution program comprising:
a read step of reading the game program from the portable recording medium;
a reception step of receiving the portable image data over the network;
an input step of receiving an input operation from the user;
an execution step of executing, based on the received input operation, the game, in accordance with the procedure indicated by the read game program, and generating, in accordance with progression of the game, a portable display image from the received portable image data; and
a display step of displaying the generated mobile image.

24. The game execution program of claim 23, stored on a computer readable recording medium.
